(19) United States
(12) Patent Application Publication
(10) Pub. No.: US 2026/0277654 A1
(43) Pub. Date: Sep. 17, 2026

(54) DEPLOYING AUTONOMOUS SOFTWARE AGENTS UTILIZING VIRTUAL MACHINE SNAPSHOTS

(71) Applicant: COGNITION AI, INC., San Francisco, CA (US)

(72) Inventors: Tony Jiang, Sunnyvale, CA (US); Scott Wu, Atherton, CA (US); Steven Hao, Atherton, CA (US); Sampriti Panda, Menlo Park, CA (US); Walden Yan, Atherton, CA (US); Adhyyan Sekhsaria, San Francisco, CA (US); Jeffrey Ling, Redwood City, CA (US); Carlo Baronio, San Francisco, CA (US); Gennady Korotkevich, Menlo Park, CA (US)

(21) Appl. No.: 19/561,211

(22) Filed: Mar. 9, 2026

Related U.S. Application Data
(60) Provisional application No. 63/770,816, filed on Mar. 12, 2025.

(51) Int. Cl. G06F 9/455; G06F 8/77

(52) U.S. Cl. CPC G06F 9/45558; G06F 8/77; G06F 2009/45583

(57) ABSTRACT

The present disclosure relates to systems, methods, and non-transitory computer-readable media that deploys an autonomous software agent and accesses a virtual machine snapshot. In particular, the disclosed systems receive a request to deploy an autonomous software agent, and the disclosed systems access a virtual machine snapshot, where the virtual machine snapshot is a custom software development environment comprising at least one of access to a code repository, access to one or more functional tools, or access to one or more code dependency libraries. Moreover, the disclosed systems execute the software task by using the autonomous software agent to perform one or more actions within the custom software development environment.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital co-pilot assistants. Over time, computing systems have been developed that generate computer code to assist (e.g., in a co-pilot like manner) a software developer in completing their computer tasks. For instance, some existing systems can assist software developers in generating code by supplementing computer code or making tweaks to existing computer code. Despite these advances, however, existing systems continue to suffer from a number of disadvantages, particularly in terms of computational efficiency, technical accuracy, and operational flexibility.

### SUMMARY

One or more embodiments described herein provide benefits and/or solve one or more problems in the art with systems, methods, and non-transitory computer-readable media that deploy an autonomous software agent and access a virtual machine snapshot, which customizes a software development environment for the autonomous software agent to execute a software task. To illustrate, in one or more embodiments, the disclosed systems access the virtual machine snapshot from a library of virtual machine snapshots, where the virtual machine snapshot acts as a save state of previous development sessions for autonomous software agents (e.g., code repository access, functional tool access, code dependency library access, environment configurations, etc.). Moreover, in one or more embodiments, the disclosed systems utilize an autonomous software agent to load a snapshot of a virtual machine at the start of each session and execute the software task by utilizing the autonomous software agent to perform actions within the custom software development environment (e.g., customized according to the snapshot).

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an autonomous software agent system accessing a virtual machine snapshot to execute a software task in accordance with one or more implementations;

FIG. 2 illustrates an example diagram of the autonomous software agent system creating a custom software development environment in accordance with one or more implementations;

FIG. 3 illustrates an example diagram of the autonomous software agent system determining a custom software development environment from an autonomous software agent executing a task and storing the custom software development environment as a virtual machine snapshot in accordance with one or more implementations;

FIG. 4 illustrates an example diagram of the autonomous software agent system saving different points of a development session within a version history as virtual machine snapshots in accordance with one or more implementations;

FIG. 5 illustrates an example diagram of the autonomous software agent system executing a software task based on accessing software composition tools in accordance with one or more implementations;

FIGS. 6A-6D illustrate example graphical user interfaces of the autonomous software agent system providing an option to create or select a virtual machine snapshot in accordance with one or more implementations;

FIGS. 7A-7B illustrate example graphical user interfaces of the autonomous software agent system providing an option to configure startup commands for a virtual machine snapshot in accordance with one or more implementations;

FIGS. 8A-8D illustrate example graphical user interfaces of the autonomous software agent system providing options to select a virtual machine snapshot or to restore a version of a virtual machine in accordance with one or more implementations;

FIG. 9 illustrates an example diagram of an architectural layer design of the autonomous software agent system which accesses various artificial intelligence models to enable an independent virtual machine computing environment of an autonomous software agent in accordance with one or more implementations;

FIG. 10 illustrates an example diagram of a virtual private cloud housing an independent virtual machine computing environment that is in communication with an autonomous agent model backend in accordance with one or more implementations;

FIG. 11 illustrates an example diagram of a frontend layer interacting with an autonomous software agent system ingestion layer and a virtual private cloud in accordance with one or more implementations;

FIG. 12 illustrates an example environment of the autonomous software agent system in accordance with one or more implementations;

FIG. 13 illustrates an example series of acts for accessing a virtual machine snapshot and executing a software task in accordance with one or more implementations;

FIG. 14 illustrates an example series of acts for determining a custom software development environment of an autonomous software agent and storing the custom software development environment in accordance with one or more implementations; and

FIG. 15 illustrates a block diagram of an exemplary computing device in accordance with one or more implementations.

### DETAILED DESCRIPTION

One or more embodiments described herein includes an autonomous software agent system that deploys an autonomous software agent by loading a virtual machine snapshot at the start of a development session. To illustrate, in one or more embodiments, an autonomous software agent system 100 deploys an autonomous software agent to load a virtual machine snapshot that includes access to code repositories, access to functional tools, and/or access to code dependency libraries. In other words, the autonomous software agent system 100 deploys the autonomous software agent with a customized virtual machine computing environment to enhance the efficiency and accuracy of executing software tasks.

In one or more embodiments, the autonomous software agent system 100 generates a virtual machine snapshot as a save state of a development session's virtual machine computing environment. In particular, the autonomous software agent system 100 provides an option for a user computing device to select a virtual machine snapshot for an autonomous software agent to start a development session (e.g., with everything that is downloaded and installed for the selected virtual machine snapshot). In other words, the autonomous software agent system 100 provides virtual machine snapshots for a user computing device to perform an initial configuration and setup to start new development sessions from a specific machine state and/or for a user computing device to resume a specific machine state from a previously ended session.

In some embodiments, the autonomous software agent system 100 determines the machine state of an autonomous software agent from executing a software task. In particular, the autonomous software agent system 100 can determine a machine state that includes at least one of an environment configuration, disk content, memory, or environment settings. Moreover, in some embodiments, the autonomous software agent system 100 can store the captured machine state (e.g., the custom software development environment) as a virtual machine snapshot for use in future development sessions or restore an autonomous software agent in a current development session to a previous machine state (e.g., due to encountering an error).

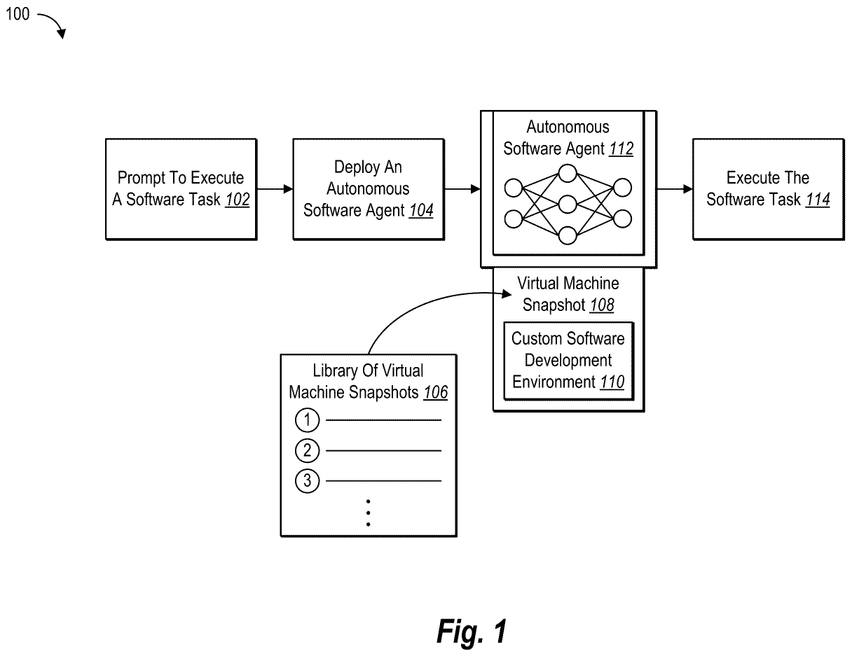

FIG. 1 illustrates an overview diagram of the autonomous software agent system 100 executing a software task based on accessing a virtual machine snapshot in accordance with one or more embodiments. For example, FIG. 1 shows the autonomous software agent system 100 accessing/receiving a prompt 102 to activate an autonomous software agent.

In one or more embodiments, the prompt 102 refers to a natural language prompt (from a user computing device), an application programming interface call, and/or a tag/mention in a third-party messaging application received by the autonomous software agent system 100. In one or more embodiments, the prompt 102 refers to a request, a question, or an instruction submitted by a user of a user account corresponding to a computing device (e.g., a user computing device). In particular, the prompt 102 includes text instructions and/or image data received from a user computing device.

Further, FIG. 1 shows the autonomous software agent system 100 performing an act 104 of deploying an autonomous software agent 112. In one or more embodiments, the autonomous software agent system 100 further performs the act of deploying the autonomous software agent 112, which is a cloned virtual machine that is isolated and can perform tasks siloed from other virtual machine computing devices. In particular, the autonomous software agent system 100 deploys the autonomous software agent 112 within an independent virtual machine computing environment and generates and runs code in its own isolated environment.

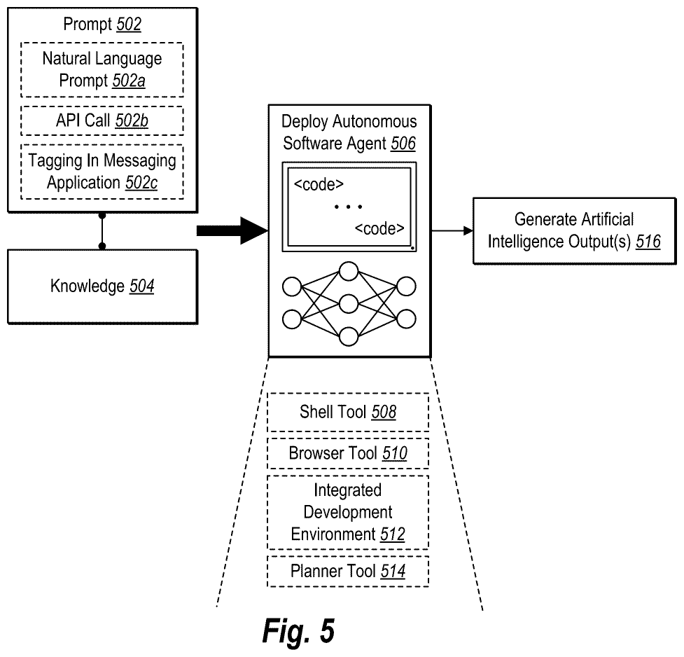

In other words, the autonomous software agent exists independently of a computing device of a user who submitted a prompt to deploy the autonomous software agent and performs tasks based on knowledge that is provided to it. Moreover, the autonomous software agent system 100 further provides the autonomous software agent with computer software composition tools. Details pertaining to the computer software composition tools are given in more detail below in the description of FIG. 5.

In one or more embodiments, the autonomous software agent system 100 provides the autonomous software agent with its own software development environment (e.g., the independent virtual machine computing environment with access to the computer software composition tools) to perform individualized tasks and not merely supplementary tasks (e.g., the autonomous software agent can deploy its own codebase by replicating an existing codebase, make changes to an existing codebase, implement changes to a codebase, and run tests for computer code generated by an autonomous software agent).

In some embodiments, the autonomous software agent includes a set of artificial intelligence models. In particular, the autonomous software agent includes one or more machine learning models, neural networks, large language models, chain-of-thought reasoning models, and/or vision-language models. Thus, the autonomous software agent system 100 deploys an autonomous software agent that operates within an independent virtual machine computing device with various machine learning components used to analyze, process, and generate information.

In one or more embodiments, a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, a language model includes a set of statistical or probabilistic functions to perform Natural Language Processing (NLP) in order to understand, learn, and/or generate human natural language content. For example, the autonomous software agent system 100 uses a language model as a tool that determines the probability of a given sequence of words occurring in a sentence or natural language sequence. Simply put, the autonomous software agent system 100 uses a model that is trained to predict the next word in a sentence.

A language model is called a large language model (LLM) when it is trained on an enormous amount of data (e.g., a threshold amount of data) and/or has a large number of parameters. These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text.

These models predict future words in a sentence letting them generate sentences similar to how humans talk and write or otherwise in a form dictated, for instance, by a prompt. In one or more implementations, an LLM utilized by the autonomous software agent system 100 employs a “chain-of-thought” reasoning approach that allows the model to internally deliberate before providing responses. Indeed, one or more implementations include a LLM trained using reinforcement learning techniques that enable the LLM to refine its reasoning skills through iterative feedback.

Additionally, FIG. 1 shows the autonomous software agent system 100 performing the act 104 of deploying the autonomous software agent 112 by accessing a virtual machine snapshot 108. In particular, FIG. 1 shows the autonomous software agent system 100 accessing the virtual machine snapshot 108 from a library of virtual machine snapshots 106. In some embodiments, the autonomous software agent system 100 automatically accesses the virtual machine snapshot 108 as the virtual machine snapshot 108 is detected as a default state (e.g., or the virtual machine snapshot 108 is detected as the most suitable relative to the prompt 102, this is explained in more detail below in FIG. 5). In some embodiments, the autonomous software agent system 100 accesses the virtual machine snapshot 108 based on a selection of the virtual machine snapshot 108 from a user computing device.

In one or more embodiments, the virtual machine snapshot 108 refers to a state of a virtual machine computing environment. For example, the virtual machine snapshot 108 refers to a customized computing environment based on a point in time within a development session of an autonomous software agent. As mentioned above, in some embodiments, the virtual machine snapshot 108 refers to a custom software development environment including at least one of access to a code repository, access to one or more functional tools, or access to one or more code dependency libraries. Moreover, the virtual machine snapshot 108 includes at least one of customized environment configurations, disk content, memory, or environment settings based on a point in time within a development session of an autonomous software agent. In other words, the virtual machine snapshot 108 can refer to a saved machine state from an autonomous software agent executing a software task and/or the virtual machine snapshot 108 can refer to a configured state (e.g., by a user computing device).

In one or more embodiments, a virtual machine snapshot 108 refers to a persistable, point-in-time representation of the execution state of a virtual machine instance that is configured to execute a software project or repository in an isolated computing environment. The virtual machine snapshot 108 may include, without limitation, a memory state, processor register state, process state, filesystem state, environment variables, dependency installations, configuration files, network configuration, and metadata sufficient to restore the virtual machine to substantially the same operational condition existing at the time the snapshot was created.

In some embodiments, a virtual machine snapshot 108 captures both (i) a base machine image defining an operating system and preinstalled toolchain, and (ii) a project-specific state comprising repository contents, build artifacts, installed dependencies, credentials scoped to the environment, and runtime context. The virtual machine snapshot 108 may be stored as a structured data object, disk image, layered image, copy-on-write delta, or other machine-readable representation.

In certain implementations, a virtual machine snapshot 108 enables deterministic reproduction of a development session by allowing subsequent instantiation of a new virtual machine instance from the snapshot, thereby restoring the filesystem hierarchy, dependency graph, runtime processes, and configuration settings without requiring reinstallation or recomputation. The virtual machine snapshot 108 may be automatically generated in response to predefined triggers, including repository initialization, dependency installation, environment configuration, task completion, or error states.

In one or more embodiments, the virtual machine snapshot 108 is associated with a specific repository identifier, branch, commit hash, or task identifier, and may be versioned, indexed, or cryptographically hashed to ensure integrity and traceability. Multiple virtual machine snapshots 108 may be maintained to represent successive states of a development workflow, thereby enabling rollback, branching, comparison, or replay of execution states.

As shown in FIG. 1, the autonomous software agent system 100 accesses the virtual machine snapshot 108 which includes a custom software development environment 110. As alluded to above, the custom software development environment 110 is customized based on a state of a virtual machine at a specific point of time within a development session of an autonomous software agent.

In one or more embodiments, the custom software development environment 110 refers to a software-based simulation customized according to a selected machine state that independently runs its own operating system and applications as a standalone machine. For example, a virtual machine computing environment 110 refers to a software-implemented computational environment that emulates a physical computing system and provides an isolated, executable runtime environment for code generation, execution, testing, modification, or orchestration by the autonomous software agent system 100. In one or more embodiments, the virtual machine computing environment 110 may operate as a system-level virtualization layer (e.g., hypervisor-based virtual machine), an operating system-level container, a language runtime virtual machine, or a custom execution sandbox, and may be dynamically provisioned, configured, and decommissioned under control of the virtual machine computing environment 110. Thus, a deployed autonomous software agent independently leverages its own independent computing environment. Thus, a deployed autonomous software agent independently leverages its own custom software development environment based on the virtual machine snapshot 108.

As shown in FIG. 1, the autonomous software agent system 100 performs an act 114 of utilizing the autonomous software agent 112 to execute a software task indicated within the prompt 102. In one or more embodiments, the software task refers to a defined unit of work in a software project to be planned, assigned, executed and/or completed. For example, the software task refers to a specific software component for the autonomous software agent system 100 to build, change, fix, and/or maintain based on requirements of the prompt 102. In other words, the software task refers to a discrete, actionable piece of work that contributes to the development, maintenance, or improvement of a software system. More specifically, a software task refers to a defined computational objective, instruction set, or problem specification that can be satisfied through the generation, modification, execution, analysis, or orchestration of computer-executable code by an artificial intelligence (AI) code-writing agent.

A software task may be expressed in natural language, structured prompts, formal specifications, source code fragments, test cases, API definitions, configuration files, user stories, or any combination thereof. In one or more embodiments, a software task defines one or more functional, logical, structural, or performance requirements that constrain or guide code generation or transformation. For example, a software task may include, without limitation: generating source code implementing specified functionality; translating code between programming languages or frameworks; completing partial code segments; refactoring, optimizing, or modifying existing code; debugging code based on error messages, stack traces, or failing tests; generating unit tests, integration tests, or documentation; constructing data pipelines, scripts, or infrastructure definitions; performing static or dynamic analysis and producing corrective modifications; or orchestrating multi-step development workflows involving code synthesis and validation.

In one or more embodiments, a software task may further include associated constraints such as target programming language, runtime environment, library dependencies, security policies, performance thresholds, coding standards, or interface requirements. In some embodiments, a software task may be decomposed into subtasks, iteratively refined, validated against automated test harnesses, or dynamically modified based on intermediate execution results. The autonomous software agent system 100 may autonomously interpret, prioritize, sequence, and execute one or more software tasks within a broader development objective. Unless expressly limited, a software task encompasses any machine-interpretable or human-specified objective that can be fulfilled, in whole or in part, through automated code generation or code manipulation.

As mentioned above, existing systems are inefficient. For example, existing systems provide code generation assistant features to assist a developer in completing their software tasks. However, these existing systems merely supplement a developer's work. In particular, existing systems require heavily involved guidance, prompting, monitoring, and the use of a developer's device in order to supplement the developer's work. In other words, existing systems merely act as a co-pilot to a developer. Accordingly, existing systems suffer from computational inefficiencies of attempting to integrate a code development assistant into a developer's workflow and often suffer from being prompted and re-prompted to yield satisfactory results (e.g., which results in wasted computational resources).

In addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, and/or logical errors.

In particular, existing systems may be able to generate computer code to supplement a developer's task, however it is often difficult or impossible to follow/understand the thought process of existing code generation systems writing computer code. Often, existing code generation systems are a black box that receive instructions and output computer code (e.g., which results in difficulties understanding how the existing code generation system arrived at its answer). As such, modifying intermediate steps of a (supplementary) software coding task performed by existing code generation systems is often infeasible.

Relatedly, existing systems suffer from operational inflexibility. Because existing systems are limited to supplementing code development for cases expressly coded by engineers, these existing systems fail to adapt to creating new computer code, tackling complex non-trivial tasks, correctly understanding already generated computer code and/or effectively performing tests on computer code. Indeed, the inflexible nature of existing systems severely hampers the ability of existing systems to keep up with the taxing demands of software development from a holistic perspective. In other words, existing systems are stuck operating as a co-pilot developer to merely supplement a software developer's workflow.

In one or more embodiments, the autonomous software agent system 100 provides several improvements over conventional systems in relation to technical accuracy, computational efficiency, and operational flexibility. In contrast to existing systems, which require heavily involved guidance, prompting, monitoring, and the use of a developer's device (in order to supplement a developer's work), the autonomous software agent system 100 deploys an autonomous software agent that operates as an independent virtual machine computing device.

In doing so, the autonomous software agent system 100 allows for an autonomous software agent to operate independently to solve non-trivial tasks, and it does not conflate or confuse the context of other ongoing tasks. Specifically, the autonomous software agent system 100 silos/isolates autonomous software agents (e.g., to operate independently with fully featured computer software composition tools discussed in more detail in FIG. 5) such that the autonomous software agents can accurately perform their assigned software tasks without being bogged down by additional information.

Relatedly, in one or more embodiments, the autonomous software agent system 100 further improves upon technical inaccuracies by accessing a virtual machine snapshot. In some embodiments, the autonomous software agent system 100 starts/resumes a development session at a specific virtual machine snapshot. In doing so, the autonomous software agent system 100 provides an autonomous software agent with a custom software development environment that includes at least one of access to a code repository, access to one or more functional tools, or access to one or more code dependency libraries. Thus, the autonomous software agent system 100 improves the success rate of executing the software task (e.g., access to a code repository, access to one or more functional tools, and/or access to one or more code dependency libraries assist the autonomous software agent in more accurately accomplishing a software task).

In one or more embodiments, the autonomous software agent system 100 further improves upon technical inaccuracies. In contrast to existing systems, which are often incomplete or inadequate in generating complex and extensive computer code, the autonomous software agent system 100 deploys an autonomous software agent that uses an intelligent orchestration process to determine how to understand a relevant code repository/environment, how to generate artificial intelligence outputs (e.g., computer code) that match a determined context, and how to choose between various artificial intelligence models to accomplish various software tasks. In some embodiments, the autonomous software agent system 100 allows a user of a computing device to configure an autonomous software agent environment (e.g., via virtual machine snapshots stored in a library of virtual machine snapshots) and then deploys the autonomous software agent to complete a software task, thus improving the technical accuracy of artificial intelligence agents performing software tasks (e.g., relative to existing systems).

In one or more embodiments, the autonomous software agent system 100 enables a user computing device to follow the work of an autonomous software agent as it performs a software coding task. For example, the autonomous software agent system 100 displays commands submitted by the autonomous software agent via a terminal, computer code being written by the autonomous software agent via an editor, and computer code being debugged by the autonomous software agent. As such, the autonomous software agent system 100 enables a user of a computing device to more accurately understand the manner in which an autonomous software agent arrived at a final result (e.g., the user computing device can follow the autonomous software agent in real-time).

Moreover, in some embodiments, the autonomous software agent system 100 determines a current state (e.g., custom software development environment) of an autonomous software agent from executing a software task. Moreover, the autonomous software agent system 100 can store the current state as a virtual machine snapshot. In other words, the autonomous software agent system 100 can store a plurality of virtual machine snapshots within a version history of virtual machine snapshots. In doing so, the autonomous software agent system 100 can provide an option to select from/restore different virtual machine states for future or current development sessions. Thus, the autonomous software agent system 100 improves the technical accuracy of future or current development sessions by storing different versions of an autonomous software agent throughout a development session to restore a specific state and more accurately accomplish a future or current software task.

Relatedly, the autonomous software agent system 100 also improves computational efficiency of software tasks by enabling options for a user computing device to follow an autonomous software agent executing a software task. In particular, as mentioned, the autonomous software agent can operate independently, and in some instances, a user can intervene or understand the steps/thought processes of an autonomous software agent by following the autonomous software agent as it switches between using different computer software composition tools.

In particular, a user computing device can follow an autonomous software agent as it switches between different computer software composition tools to execute a software task. In doing so, the autonomous software agent system 100 saves computational resources and time as a user can more efficiently understand the process of an autonomous software agent (e.g., as it performs a task or after it performs a task) and the user computing device can intervene at one or more points in the development session to aid/assist an autonomous software agent.

Moreover, as mentioned above, the autonomous software agent system 100 can provide a custom software development environment (e.g., via accessing a virtual machine snapshot) to an autonomous software agent. In particular, the autonomous software agent system 100 improves computational efficiency by quickly accessing relevant environment configuration, disk content, memory, environment settings, code repositories, functional tools, and/or code dependency libraries.

As also mentioned above, the autonomous software agent system 100 can save machine states within a version history. In doing so, the autonomous software agent system 100 also improves computational efficiency as saved machine states within a version history allow a user computing device to quickly and efficiently restore an autonomous software agent to a desired point within a (future) development session.

Furthermore, the autonomous software agent system 100 improves computational efficiency by enabling a user computing device to continue to delegate entire non-trivial software coding tasks to the autonomous software agent while the autonomous software agent is already working completely asynchronously. As the autonomous software agent is executing a software coding task, a user can delegate multiple additional autonomous software agents to perform additional software tasks. Thus, the autonomous software agent system 100 enables large-scale parallelization of tasks.

In one or more embodiments, the autonomous software agent system 100 further improves upon operational inflexibilities. In contrast to existing systems, which are rigidly tied to code supplementation, the autonomous software agent system 100 deploys an autonomous software agent that operates within a custom software development environment and further allows a user to monitor/modify the progress of the autonomous software agent (if so desired). Moreover, because the autonomous software agent system 100 deploys an autonomous software agent that is provided with various development box tools, the autonomous software agent acts as an advanced reasoning tool to complete non-trivial tasks. Accordingly, the autonomous software agent system 100 enhances the flexibility of operations in performing code generation tasks relative to existing systems.

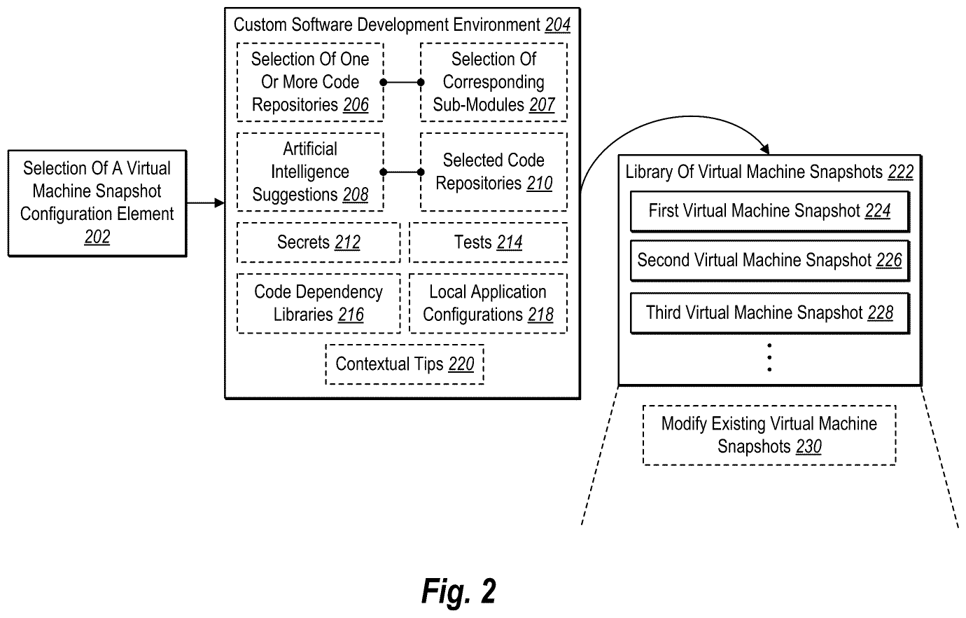

FIG. 2 illustrates the autonomous software agent system 100 receiving a selection of an option to create a virtual machine snapshot in accordance with one or more embodiments. For example, FIG. 2 shows the autonomous software agent system 100 performing an act 202 of receiving a selection of a virtual machine snapshot configuration element. In one or more embodiments, the virtual machine snapshot configuration element refers to a graphical user interface element that the autonomous software agent system 100 provides for display to a user computing device. In particular, the virtual machine snapshot configuration element refers to an option provided by the autonomous software agent system 100 to create a virtual machine snapshot with one or more customized settings.

As shown in FIG. 2, the autonomous software agent system 100 receives the selection of the virtual machine snapshot configuration element and generates a custom software development environment 204. In one or more embodiments, the autonomous software agent system 100 provides various configuration options for a user computing device to configure the custom software development environment. In particular, FIG. 2 shows that in some embodiments, the custom software development environment 204 includes a selection of one or more code repositories 206, a selection of corresponding sub-modules 207, artificial intelligence suggestions 208, selected code repositories 210 (e.g., based on the artificial intelligence suggestions 208), secrets 212, tests 214, code dependency libraries 216, local application configurations 218, and/or contextual tips 220.

In one or more embodiments, the one or more code repositories 206 refer to a centralized location where software computer code is stored, managed, and controlled (e.g., controlled for different deployment versions such as development, web application, cloud, etc.). In particular, the one or more code repositories 206 includes computer code, computer code documentation (e.g., files explaining how to use, setup, and contribute to one or more projects), configuration files (e.g., environment configuration, application configuration, deployment configuration, etc.), and assets (e.g., images, CSS files, JavaScript files, fonts, external libraries, audio/video files, etc.).

In one or more embodiments, the computer code documentation refers to written documents that explain how computer code works and how to utilize the computer code. For example, the computer code documentation can include comments inside the code, README files, API documents (e.g., application programming interface), and set up and usage documents. In particular, the computer code documentation can help an autonomous software agent understand, maintain, and correctly use software computer code (e.g., in a code repository, also known as an internal code library).

In one or more embodiments, the corresponding sub-modules 207 refer to a reference inside a code repository that points to a specific commit of another code repository, allowing a code repository management system to reuse code without copying the computer code in another code repository. In some embodiments, the corresponding sub-modules 207 refer to another subdirectory of a parent code repository. In particular, the corresponding sub-modules 207 can include references to shared internal libraries and assist code repository management systems in version stability and compliance for different repositories.

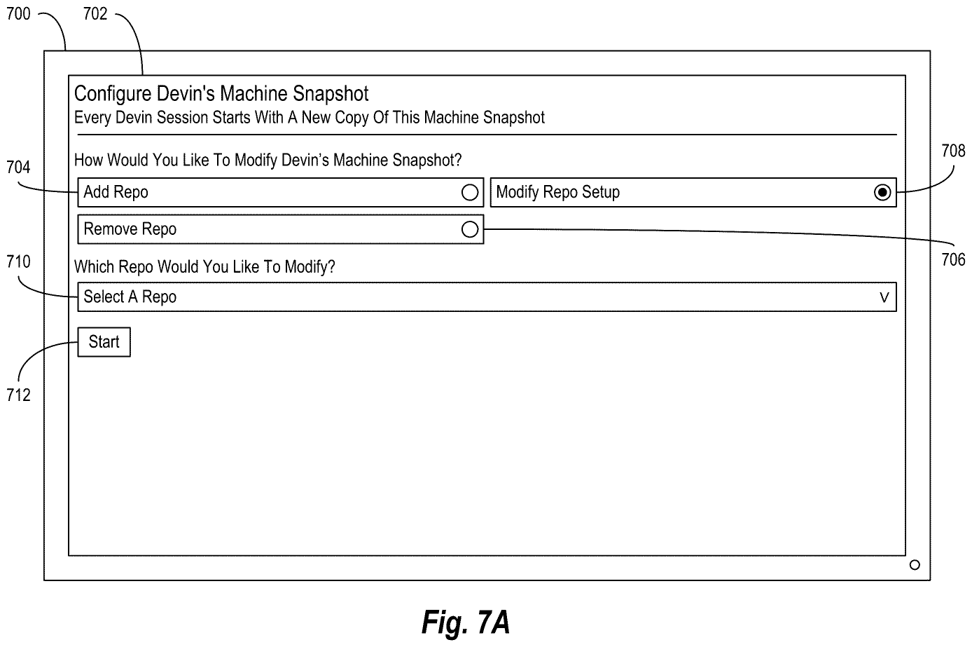

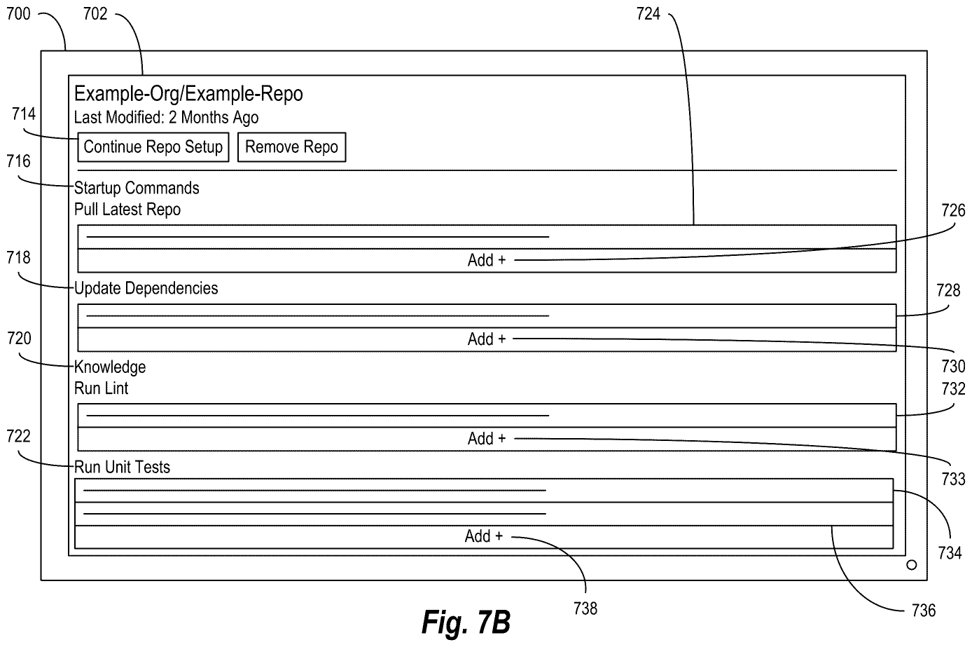

In one or more embodiments, the artificial intelligence suggestions 208 refer to suggestions generated by the autonomous software agent system 100 and surfaced to a user computing device that selected the virtual machine snapshot configuration element. In particular, the autonomous software agent system 100 recommends to a user computing device configuration settings for the custom software development environment. For example, the autonomous software agent system 100 generates the artificial intelligence suggestions 208 based on analyzing the selected code repositories 210. Additional details regarding the artificial intelligence suggestions 208 are provided below in the description of FIG. 7B.

In one or more embodiments, a secret refers to a set of information used to authenticate and authorize access to a system, service, resource, or computing environment. For example, the secret refers to a proof of identity and defines what actions a holder of the secret is permitted to perform. Furthermore, in some embodiments, the secret includes a secret type, a secret name, a token, a redaction option, and a context. In some embodiments, the secret type includes global secrets, repository-specific secrets, session-specific secrets, raw secrets, site cookies, and time-based one-time passwords.

In one or more embodiments, the secret name refers to a human-readable identifier used to reference and manage a secret. In particular, the secret name refers to a label and does not grant access by itself. For instance, the secret name can assist a computer system in auditing, configuring, and troubleshooting problems related to the secret (e.g., the secret name acts as a reference). In one or more embodiments, the token refers to a secret or cryptographic value that is actually presented to a system to authenticate access. In particular, the token refers to an API key, an OAuth token, and other private keys.

In one or more embodiments, the redaction option refers to an option that defines whether the access credential is masked, hidden, or excluded when displayed, logged, or transmitted. For example, the autonomous software agent system 100 can scrub the token from being viewed by a large language model component of an autonomous software agent executing a software task.

In one or more embodiments, the context of the secret refers to the scope and conditions under which the secret is valid and intended to be used. In particular, the context of the secret can include the associated system or service for the secret, an environment (e.g., development, staging, or production) for using the secret, permission or roles for using the secret, expiration or rotation rules for the secret, and usage constraints (e.g., internet protocol range, region restrictions, time restrictions, workload restrictions) of the secret.

Furthermore, in one or more embodiments, the tests 214 refer to automated checks that measure code quality, rather than correctness. In particular, the tests 214 can include quality tests, which refer to a process of tests that analyze linters (e.g., formatting and style rules), static analysis tools, code coverage thresholds, and security or dependency vulnerability scans. Moreover, in some embodiments, the tests 214 can include automated tests that verify that software (e.g., computer code) behaves correctly. In particular, the tests 214 can further improve the technical accuracy and efficiency of an autonomous software agent executing a software task by setting up test frameworks, test data, mocks, and test environments.

In one or more embodiments, the code dependency libraries 216 refer to a collection of reusable computer code that a software project relies on to function. In other words, the code dependency libraries 216 refer to computer code for a software program that calls, imports or links against a code dependency library (e.g., a software project depends on a code dependency library but does not implement the code dependency library itself). In some embodiments, the code dependency libraries 216 include projects and specific dependencies to keep an autonomous software agent appraised/up to date with the necessary skills/context to execute a software task. To illustrate, the code dependency libraries 216 include external libraries, frameworks, and/or tools that a software program relies on to run or to build correctly.

Additionally, in some embodiments, the local application configurations 218 refer to steps required to run an application on a virtual machine (e.g., independent/custom virtual machine computing environment) of an autonomous software agent. In particular, the local application configurations 218 include configuring environment variables, local databases, services, and startup commands. To illustrate, the local application configurations 218 can include running local servers, connecting to local or sandbox services, and configuring environment files.

In one or more embodiments, the contextual tips 220 (e.g., of the custom software development environment 204) refer to guidelines that explain how to effectively use the one or more code repositories 206. For example, the contextual tips 220 include guidelines for an autonomous software agent, such as which functions (e.g., within a code repository) to prefer or to avoid, common pitfalls that are encountered when operating within the one or more code repositories 206, and performance or security considerations. In other words, the contextual tips 220 provide guidance to an autonomous software agent to prevent mistakes and help the autonomous software agent efficiently use internal tools of the custom software development environment 204.

In one or more embodiments, the autonomous software agent system 100 can further include customized skills as part of the custom software development environment 204. For example, the skills refer to specialized skills for an autonomous software agent system to further customize their development environment for more accurately and efficiently executing a task. For example, the skills can include installing language runtimes within the development environment of the autonomous software agent, configuring environment variables, connecting to internal services (e.g., databases, APIs, authentication systems), and resolving code dependency conflicts. In other words, the specialized skills assist the autonomous software agent in matching a software task's requirements such that software programs run correctly.

As further shown in FIG. 2, the autonomous software agent system 100 generates the custom software development environment 204 (e.g., in response to a selection of the virtual machine snapshot configuration element) and saves the custom software development environment 204 as a virtual machine snapshot. In particular, FIG. 2 shows the autonomous software agent system 100 saving the custom software development environment 204 as a virtual machine snapshot in a library of virtual machine snapshots 222. For example, FIG. 2 shows the library of virtual machine snapshots 222 include a first virtual machine snapshot 224, a second virtual machine snapshot 226, a third virtual machine snapshot 228, etc.

Moreover, FIG. 2 shows that the autonomous software agent system 100 provides a modification option 230 to modify existing virtual machine snapshots. In one or more embodiments, in response to a selection of the modification option 230, the autonomous software agent system 100 receives a selection of a specific virtual machine snapshot within the library of virtual machine snapshots 222 and allows a user computing device to make modifications to how the selected virtual machine snapshot is currently configured.

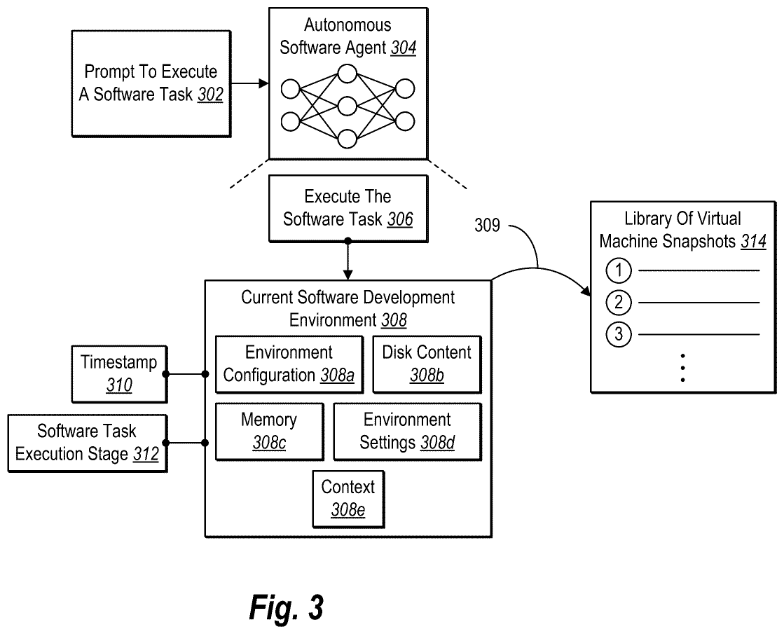

FIG. 3 illustrates the autonomous software agent system 100 utilizing an autonomous software agent to execute a software task and determine a current machine state of the autonomous software agent in accordance with one or more embodiments. For example, FIG. 3 shows the autonomous software agent system 100 receiving a prompt 302 to execute a software task and the autonomous software agent system 100 deploying autonomous software agent 304.

As shown in FIG. 3, the autonomous software agent system 100 performs an act 306 of executing the software task utilizing the autonomous software agent 304. Moreover, in some embodiments, the autonomous software agent system 100 determines a current software development environment 308 from executing the software task. In particular, the autonomous software agent system 100 determines the current software development environment 308 of the autonomous software agent 304 at a particular point within a development session.

As shown in FIG. 3, the autonomous software agent system 100 determines an environment configuration 308a, disk content 308b, memory 308c, environment settings 308d, and context 308e as part of determining the current software development environment 308. In one or more embodiments, the autonomous software agent system 100 also determines access to a code repository, access to one or more functional tools, and/or access to one or more code dependency libraries (e.g., granted by a user computing device during the course of executing the software task and/or at the start of the development session).

In one or more embodiments, the environment configuration 308a refers to a set of defined parameters that control how an application or system (e.g., the autonomous software agent 304) behaves in a specific environment (e.g., a development environment, a testing environment, a staging environment, a product environment). In particular, the environment configuration 308a refers to contents of the autonomous software agent 304, such as service endpoints (e.g., where the autonomous software agent 304 sent requests or listened for requests, as different environments run on different instances of the same API requesting service), feature flags (e.g., switches that change functionality of the autonomous software agent 304 when testing features in different environments such as deployment and release environments), and runtime modes (e.g., how an application behaves that was being run by the autonomous software agent 304, such as a debug mode or a release mode) utilized during execution of the software task.

In one or more embodiments, the disk content 308b refers to persistent data stored on storage media of the autonomous software agent 304 as the autonomous software agent 304 executed the software task. For example, the disk content 308b includes source code, compiled binaries, installed libraries, configuration files, logs, databases, caches, etc. In other words, the disk content 308b refers to persistent memory across restarts for a computing device (e.g., an independent virtual machine computing device such as the autonomous software agent 304).

In one or more embodiments, the memory 308c refers to temporary memory that is in-use data that is actively loaded while programs are running for the autonomous software agent 304. For example, the memory 308c can include running processes, variables and objects, in-memory caches, and loaded code segments. In one or more embodiments, the environment settings 308d refer to runtime values injected into a process by the autonomous software agent 304 that influence behavior without changing computer code. In particular, the environment settings 308d can include environment variables, locale and time zone, user permissions, and runtime flags. In other words, the environment settings 308d refer to run-time level values, not files or infrastructure of the autonomous software agent 304.

In one or more embodiments, the context 308e of the autonomous software agent 304 executing the software task refers to a full operational situation of the autonomous software agent 304. For example, the context 308e refers to a summary of the environment configuration 308a, the disk content 308b, the memory 308c, and the environment settings 308d that gives a holistic picture of the “how” for executing the software task.

Moreover, FIG. 3 shows that as part of the autonomous software agent system 100 determining the current software development environment 308, the autonomous software agent system 100 also determines a timestamp 310 and a software task execution stage 312. In one or more embodiments, the timestamp 310 refers to a specific point in time of the autonomous software agent 304 executing the software task. Moreover, the software task execution stage 312 refers to a specific portion of the software task (e.g., a first sub-task, a second sub-task, etc.).

Additionally, FIG. 3 shows the autonomous software agent system 100 performing an act 309 of storing/saving the current software development environment 308 within a library of virtual machine snapshots 314. For example, the autonomous software agent system 100 stores the current software development environment 308 of the autonomous software agent 304 within the library of virtual machine snapshots 314 for future recall/restoration.

In one or more embodiments, the autonomous software agent system 100 stores a plurality of software development environments as a plurality of virtual machine snapshots within the library of virtual machine snapshots 314. In other words, during the course of a development session, the autonomous software agent system 100 stores multiple different machine states of the autonomous software agent 304 as it executes a software task. In this manner, the autonomous software agent system 100 allows a user computing device to restore the autonomous software agent 304 to a previous machine state as it executes the software task in a current development session or the autonomous software agent system 100 allows a user computing device to restore a previous machine state of the current development session for a future development session.

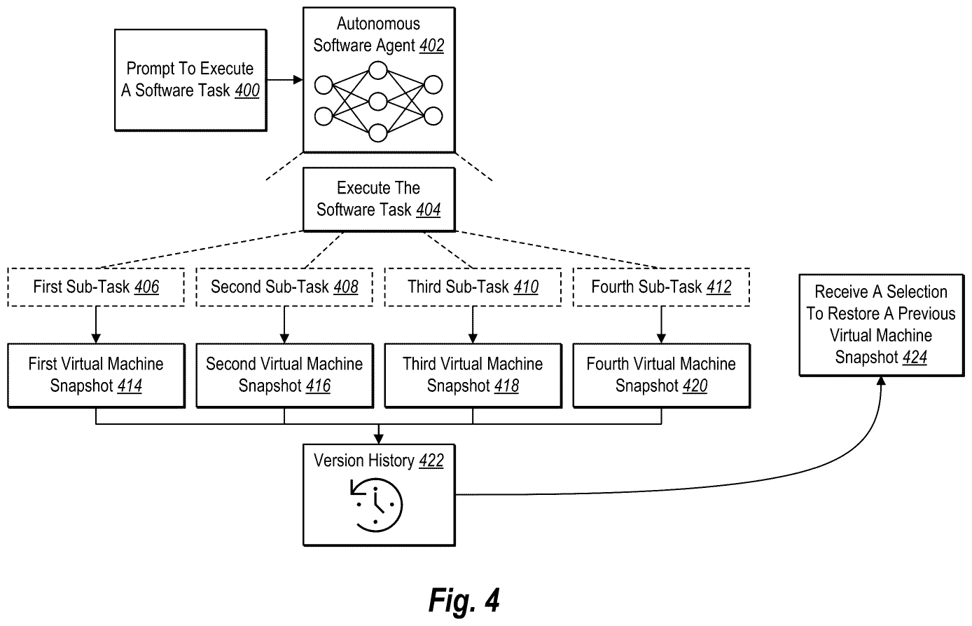

FIG. 4 illustrates an example diagram of the autonomous software agent system 100 storing a plurality of machine states within a version history in accordance with one or more embodiments. For example, FIG. 4 shows the autonomous software agent system 100 receiving/accessing a prompt 400 to execute a software task, and in response, deploying an autonomous software agent 402.

As shown in FIG. 4, the autonomous software agent system 100 deploys the autonomous software agent 402 to execute a software task 404. In particular, FIG. 4 shows that in some embodiments, as part of executing the software task 404, the autonomous software agent system 100 determines a first sub-task 406, a second sub-task 408, a third sub-task 410, and a fourth sub-task 412 of the software task 404 (e.g., via generating an artificial intelligence plan that is discussed in more detail below in the description of FIG. 5).

Moreover, FIG. 4 shows the autonomous software agent system 100 determining a first virtual machine snapshot 414, a second virtual machine snapshot 416, a third virtual machine snapshot 418, and a fourth virtual machine snapshot 420 that correspond respectively with the first sub-task 406, the second sub-task 408, the third sub-task 410, and the fourth sub-task 412. As discussed above in FIG. 3, each of the virtual machine snapshots includes a custom software development environment at their respective point in time within the development session.

Additionally, FIG. 4 shows the autonomous software agent system 100 storing the first virtual machine snapshot 414, the second virtual machine snapshot 416, the third virtual machine snapshot 418, and the fourth virtual machine snapshot 420 within a version history 422. In one or more embodiments, the version history 422 refers to a record of virtual machine snapshots throughout a plurality of development sessions for a plurality of autonomous software agents. In particular, the version history 422 captures what changed about a software development environment and when the software development environment changed for different autonomous software agents throughout different development sessions. For example, the autonomous software agent system 100 can utilize the version history 422 as a library of virtual machine snapshots.

As shown in FIG. 4, the autonomous software agent system 100 receives a selection 424 to restore a previous virtual machine snapshot from the version history 422. For example, the autonomous software agent system 100 can receive the selection 424 during the development session of the autonomous software agent 402 executing the software task 404 and/or the autonomous software agent system 100 can receive the selection 424 in a future development session of another autonomous software agent executing another software task.

FIG. 5 illustrates the autonomous software agent system 100 generating artificial intelligence outputs from utilizing software composition tools. For example, FIG. 5 shows the autonomous software agent system 100 accessing/receiving a prompt 502. In particular, the prompt 502 refers to a natural language prompt 502a (from a user computing device), an application programming interface call 502b, and/or a tag/mention 502c in a messaging application.

In some embodiments, via an API, a user computing device can build custom workflows using an API of the autonomous software agent system 100 and programmatically assign tasks for the autonomous software agent system 100 to perform. Further, with the API, users of computing devices can essentially plug the autonomous software agent system 100 into any of their software development and internal tools.

In some embodiments, the autonomous software agent system 100 deploys an autonomous software agent in response to being triggered by a code editor. In particular, from another code editor/integrated development environment (IDE), user computing devices who use visual studio code (or visual studio code forks) can assign tasks to the autonomous software agent system 100 directly from their code editor/IDE.

In some embodiments, the autonomous software agent system 100 can deploy an autonomous software agent in response to being tagged/mentioned in a third-party messaging application. In particular, user computing devices can tag the autonomous software agent system 100 directly from conversations they are having with colleagues in the third-party messaging application. Furthermore, the autonomous software agent system 100 will reply directly in the messaging thread and anyone can jump into the thread and provide further instructions to the autonomous software agent system 100.

In some embodiments, the autonomous software agent system 100 integrated with a third-party messaging application further includes a centralized server. In particular, the autonomous software agent system 100 utilizes a centralized server that is responsible for forwarding information between the autonomous software agent system 100 and the third-party messaging application. To illustrate, a user of a computing device can install a messaging integration for the autonomous software agent system 100 into a messaging workspace and further add the integration to the relevant channels of a third-party messaging application.

In some embodiments, if the autonomous software agent system 100 receives a tag/mention of an autonomous software agent in the third-party messaging application, then the autonomous software agent system 100 utilizes a centralized server to recognize the tag/mention. Furthermore, the autonomous software agent system 100 passes that tag/mention along to a web server backend that a website hosted by the autonomous software agent system 100 uses to start a new session (e.g., initiate an autonomous software agent for deployment).

As further shown in FIG. 5 and as discussed above, the autonomous software agent system 100 further accesses/receives knowledge 504. In particular, the knowledge 504 can include a development environment, guidelines, code repositories, and/or one or more software tasks from the knowledge library discussed above. In some embodiments, the knowledge 504 refers to a form of “memory” (e.g., memory inputs) that allows the autonomous software agent system 100 to retrieve information based on specific triggers that might be relevant to a session of the autonomous software agent. In some embodiments, the knowledge 504 can include a development environment, guidelines, code repositories, and a software task. In some embodiments, the knowledge 504 includes information obtained from a virtual machine snapshot (e.g., as discussed above in FIGS. 1-4).

As further shown in FIG. 5, the autonomous software agent system 100 further performs an act 506 of deploying an autonomous software agent (e.g., a cloned virtual machine that is isolated and can perform tasks siloed from other devices). Moreover, as shown in FIG. 5, the autonomous software agent system 100 further provides to the autonomous software agent a shell tool 508, a browser tool 510, an integrated development environment 512 (e.g., editor), and a planner tool 514.

For example, a shell tool 508 refers to an interface layer that mediates interaction between an artificial intelligence (AI) agent and an underlying execution environment, computing system, development environment, or virtualized runtime. The shell tool 508 provides a structured command, control, and input/output framework through which the autonomous software agent system 100 issues instructions, receives responses, and orchestrates software development operations. A shell tool 508 may comprise a command-line interpreter, application programming interface (API) interface, remote procedure call (RPC) interface, messaging interface, terminal emulator, container interface, virtual machine interface, or any combination thereof. The shell tool 508 abstracts underlying system resources-including file systems, process control, compilers, interpreters, debuggers, network interfaces, and package managers- and presents a controllable operational surface to the autonomous software agent system 100.

As used herein, a browser tool 510 (or simply browser) refers to a software component executing within an independent virtual machine computing environment and configured to retrieve, render, interpret, and interact with network-accessible resources on behalf of an autonomous software agent system 100. A browser tool 510 operates as a controlled network interaction interface within the independent virtual machine computing environment and provides the autonomous software agent system 100 with programmatic access to web content, application interfaces, documentation repositories, APIs, development resources, and other remote computing services. A browser tool 510 may implement one or more communication protocols, including HTTP, HTTPS, WebSocket, or other network transport protocols.

In the context of the autonomous software agent system 100, a browser tool 510 may be configured to retrieve web pages, API responses, source code repositories, software documentation, or structured data from remote systems; render and parse markup languages including HTML, XML, Markdown, and script-generated content; execute client-side scripts in a sandboxed runtime; extract structured representations of document object models (DOMs), metadata, form fields, and interactive elements; submit forms, authenticate sessions, manage cookies or tokens, and maintain session state; download, upload, or modify remote resources under controlled permissions; provide machine-readable representations of rendered content to the autonomous software agent system 100 for reasoning and code generation; and enforce network policies, domain restrictions, rate limits, and security guardrails.

In some embodiments, a browser tool 510 is configured to expose structured outputs—such as DOM trees, accessibility trees, rendered text, event traces, console logs, or network traces—rather than or in addition to graphical output. A browser tool 510 may operate in headless mode and may be programmatically controlled via an automation interface.

A browser tool 510, as part of the independent virtual machine computing environment, is isolated from a host computing system and subject to resource constraints, execution monitoring, and security policies defined by the independent virtual machine computing environment. This isolation permits the autonomous software agent system 100 to perform research, dependency resolution, API inspection, automated testing of web applications, or code retrieval without exposing the host environment to uncontrolled network interactions. Unless expressly limited, a browser tool 510 encompasses any web client, headless browsing engine, embedded rendering engine, automated browsing framework, or network-interaction module configured to retrieve and interact with remote content within a virtualized execution environment controlled by the autonomous software agent system 100.

In some embodiments, the integrated development environment (IDE) 512 refers to an editor tool to write computer code and computer tests. In some embodiments, the integrated development environment 512 is a software application that brings together software tools for software development. In particular, the integrated development environment 512 refers to a software application that combines essential software development features (e.g., coding, debugging, testing, and deployment) to increase the efficiency of completing software projects. The IDE 512 may further maintain structured representations of a project state, including file hierarchies, dependency graphs, abstract syntax trees (ASTs), symbol tables, error diagnostics, execution traces, and build artifacts. In the context of the autonomous software agent system 100, the IDE 512 is configured to one or more software tasks; create, edit, refactor, or delete source files; invoke compilation or interpretation processes; execute unit tests or integration tests; surface compiler diagnostics and runtime errors; perform automated refactoring or formatting; manage branches and commits within a version control system; and return structured, machine-readable feedback to the autonomous software agent system 100 to enable iterative reasoning and code refinement.

In some embodiments, the integrated development environment 512 is a fully featured application that allows an autonomous software agent to write, test, and debug code without switching between different software applications. For example, the integrated development environment can include a code editor (e.g., syntax highlighting, code completion, etc.), a compiler/interpreter (e.g., converts source code into executable program code), a debugger (e.g., to find and fix computer code errors), a file browser (e.g., to navigate through files in a centralized development platform), version control (e.g., commit, push, pull, merge computer code in a code repository), and a terminal (e.g., direct command execution to run scripts or access computer system utilities).

In some embodiments, the autonomous software agent system 100 provides a code editor to the autonomous software agent, where the code editor is a sub-component of the integrated development environment. In other words, in some embodiments, the autonomous software agent system 100 provides a fully featured IDE that merges the functionalities of a code editor and the shell tool 508.

Accordingly, the autonomous software agent system 100 provides the autonomous software agent with its own IDE (e.g., independent of a computer code development environment of a user computing device that submitted the prompt 502) to perform software coding tasks. In other words, the autonomous software agent has full access to the integrated development environment 512, which enables the autonomous software agent to complete complex software development tasks.

In one or more embodiments, the planner tool 514 refers to an artificial intelligence model that analyzes a prompt 502 and plans how to execute one or more corresponding software tasks. In particular, the planner tool 514 breaks down a software task to manageable tasks and generates an artificial intelligence plan. In some embodiments, the autonomous software agent system 100 utilizes the planner tool 514 to generate the artificial intelligence plan and presents the artificial intelligence plan to a user computing device to modify or confirm one or more aspects in the artificial intelligence plan.

More specifically, that planner tool is configured to analyze one or more input objectives, user intents, or software task specifications and to generate structured, multi-step plans that guide operation of an autonomous software agent system 100 in performing code generation, modification, testing, analysis, or orchestration tasks. The planner tool 514 may be implemented using one or more underlying computational models, including but not limited to large language models (LLMs), transformer-based neural networks, sequence-to-sequence models, reinforcement learning models, probabilistic graphical models, symbolic reasoning engines, constraint solvers, heuristic search algorithms, or hybrid neuro-symbolic architectures. In one or more embodiments, planner tool 514 leverages a generative pretrained transformer model, including a code-capable language model, to infer task structure, identify implicit constraints, and predict ordered action sequences based on prior training across natural language corpora, source code repositories, execution traces, and software development workflows.

In one or more embodiments, the planner tool 514 is configured to decompose complex objectives into a sequence of actionable subtasks, determine dependencies and ordering among subtasks, and construct an execution plan consumable by downstream components such as code generation modules, debugging modules, the browser tool 510, the shell tool 508, IDE 512, testing frameworks, or other tool interfaces. The generated plan may comprise, without limitation, a hierarchical task tree, directed acyclic graph (DAG), ordered action list, state machine representation, or other structured plan representation including defined inputs, outputs, preconditions, postconditions, and success criteria.

In certain embodiments, planner tool 514 employs prompt-based reasoning, chain-of-thought inference, tree search, beam search, Monte Carlo sampling, reinforcement learning-based policy selection, or combinations thereof to evaluate multiple candidate plans and select or refine a plan according to defined optimization metrics. The planner tool 514 may further incorporate memory mechanisms, including contextual embeddings, vector databases, episodic execution logs, or persistent state representations, to inform plan generation based on prior interactions or historical outcomes. The planner tool 514 may monitor intermediate execution results and dynamically revise, re-order, expand, or prune subtasks based on feedback including compiler diagnostics, runtime errors, test failures, environmental changes, or external tool responses. In this manner, planner tool 514 supports iterative, adaptive, reactive, or predictive planning strategies. In some embodiments, the planner tool 514 operates as a distinct module that communicates with other components of autonomous software agent system 100 via structured messages, application programming interfaces (APIs), or message-passing protocols.

In one or more embodiments, the autonomous software agent system 100 utilizes the planner tool 514 to generate an artificial intelligence plan in accordance with one or more embodiments. In particular, the autonomous software agent system 100 accesses/receives the prompt 502 (e.g., from a user computing device). Furthermore, the autonomous software agent system 100 deploys an autonomous software agent to operate within an independent/custom virtual machine computing environment.

In one or more embodiments, the autonomous software agent system 100 utilizes the planner tool 514 to improve the efficiency and accuracy of executing a software task from the prompt 502. In some embodiments, the autonomous software agent system 100 utilizes the planner tool to generate a running “to do” list. In particular, the autonomous software agent system 100 can use the planner tool 514 to break down the prompt 502 and to infer one or more intents of the prompt 502. In one or more embodiments, the autonomous software agent system 100 utilizes the planner tool 514 to assist a user computing device in visualizing how the autonomous software agent (e.g., deployed by the autonomous software agent system 100) plans and thinks through solving a problem (e.g., as indicated in the prompt 502).

In some embodiments, the autonomous software agent system 100 utilizes a large language model (e.g., a planning model) to analyze the prompt 502. In one or more embodiments, the autonomous software agent system 100 utilizes the large language model that leverages retrieval-augmented generation (RAG) to generate an artificial intelligence plan. In some embodiments, retrieval-augmented generation refers to retrieving relevant information from an external database or knowledge source in the context of the prompt 502. In particular, the autonomous software agent system 100 can utilize RAG (e.g., which includes using the large language model) to generate a response (e.g., the artificial intelligence plan) by leveraging both the retrieved information (from an external source) and its own internal knowledge base. In particular, the autonomous software agent system 100 leverages RAG, which includes an input query, information retrieval, and response generation to perform a task of generating the artificial intelligence plan.

In some embodiments, the autonomous software agent system 100 further utilizes the large language model to perform an act of extracting a meta-task from the prompt 502. Moreover, as shown, the autonomous software agent system 100 performs an act of extracting intermediate tasks (e.g., sub-tasks) from the meta-task. In one or more embodiments, the autonomous software agent system 100 analyzes the prompt 502, determines an intent (e.g., a meta-task) of the prompt 502, and determines discrete sub-tasks (e.g., intermediate tasks).

In particular, the autonomous software agent system 100 can prompt the large language model to divide the prompt 502 into manageable and discrete sub-portions. In other words, the autonomous software agent system 100 prompts the large language model to identify tasks that point to different code repositories, data sources, and systems as being their own sub-task. In particular, the autonomous software agent system 100 can prompt the large language model and include example breakdowns of example requests.

Moreover, in some embodiments, the autonomous software agent system 100 trains the large language model with example datasets for breaking down a request into a meta-task and a plurality of sub-tasks. In particular, the autonomous software agent system 100 trains the large language model by having it generate a predicted artificial intelligence plan and then comparing the prediction to a ground truth reference.

In some embodiments, the autonomous software agent system 100 utilizes the large language model to generate an artificial intelligence plan to execute a software task. In particular, the autonomous software agent system 100 generates the artificial intelligence plan which includes a meta-task extracted from the prompt 502 and intermediate tasks extracted from the meta-task. In one or more embodiments, the autonomous software agent system 100 provides the artificial intelligence plan to a graphical user interface of a computing device. In particular, the autonomous software agent system 100 provides the artificial intelligence plan to receive approval or modification from a user computing device.

In some embodiments, the autonomous software agent system 100 can receive modifications to one or more tasks/sub-tasks and/or the meta-task extracted from the prompt 502. In some instances, the autonomous software agent system 100 can receive additional context or additional files to further customize the artificial intelligence plan. In some embodiments, the autonomous software agent system 100 receives one or more modifications to the artificial intelligence plan and generates a modified artificial intelligence plan.

Further, the autonomous software agent system 100 can prompt a user of a computing device to provide approval of the modified artificial intelligence plan. In response to receiving approval of an (updated) artificial intelligence plan, the autonomous software agent system 100 deploys the autonomous software agent to execute the prompt 502 according to the artificial intelligence plan.

Accordingly, in one or more embodiments, the autonomous software agent system 100 can utilize the planner tool 514 to determine a specific sub-task currently being executed by an autonomous software agent. In particular, as mentioned above, the autonomous software agent system 100 can save specific machine states within a development session with a timestamp and a flag indicating a specifically detected sub-task. For example, the autonomous software agent system 100 can reference the artificial intelligence plan when saving a specific machine state (e.g., virtual machine snapshot) of an autonomous software agent.

Moreover, in some embodiments, the autonomous software agent system 100 automatically detects a virtual machine snapshot (e.g., as discussed above in FIGS. 1-4) to implement based on utilizing the planner tool 514 to generate an artificial intelligence plan. In particular, the autonomous software agent system 100 can generate the artificial intelligence plan and compare the meta-task/sub-tasks of the artificial intelligence plan with a library of virtual machine snapshots. Furthermore, the autonomous software agent system 100 can generate a virtual machine snapshot suggestion for a user computing device to confirm or reject. As also discussed above, in some embodiments, the autonomous software agent system 100 receives a selection of a specific virtual machine snapshot from the user computing device.

In some embodiments, the autonomous software agent system 100 utilizes the browser tool 510 to perform one or more actions responsive to prompt 502 to execute a software task. For example, the autonomous software agent system 100 accesses/receives the prompt 502. In one or more embodiments, the autonomous software agent system 100 utilizes the browser tool 510 to browse documentation on one or more website domain pages, test web applications (e.g., local applications), download information, upload information, etc. In particular, the autonomous software agent system 100 utilizes the browser tool 510 to perform a first navigation step, a second navigation step, and a third navigation step on a website page.

In one or more embodiments, a website page (e.g., a website domain page) refers to a webpage hosted under a domain name that serves as an entry point of a website and is identified by a URL. For example, a website page refers to a digital webpage associated with a domain name that has a unique URL and contains structured content (e.g., text, images, links, and other media). In particular, a website page is part of a larger website hierarchy. To illustrate, a website hierarchy includes a homepage, subpages, and subdomain pages. In some embodiments, a plurality of website pages is associated with an entity.

In one or more embodiments, the autonomous software agent system 100 utilizes the browser tool 510 to obtain information from a website page. In some embodiments, the autonomous software agent system 100 determines whether a particular portion of a website page is relevant to the prompt 502 to execute a software task. In particular, the autonomous software agent system 100 utilizes a large language model (e.g., a website relevance model) to determine the relevance of a sub-portion, portion, or entire website page.

In other words, website domain pages contain an excessive amount of information. In particular, large language models are typically bogged down with processing all elements within a website page. Thus, the autonomous software agent system 100 distills a website page structure (e.g., utilizing the large language model) and provides a simplified structure (e.g., HTML) to the autonomous software agent for further processing. In doing so, the autonomous software agent system 100 enables the autonomous software agent to process a large amount of data from website pages without performance degradation.

In some embodiments, the autonomous software agent system 100 utilizes the large language model to perform an act of determining a document object model (DOM) of a website page. In particular, the autonomous software agent system 100 passes a website page to the large language model to determine a document object model of the website page.

In one or more embodiments, a document object model refers to a structured, hierarchical representation of a webpage's content that defines how HTML elements are programmatically accessed, modified, and analyzed. In one or more embodiments, the autonomous software agent system 100 detects a document object model object within a website page. For example, the DOM includes a representation of structure, content and properties within a website page. For instance, a user of a website page interacts with and manipulates a DOM object. Further, in some embodiments the DOM includes HTML or XML format. Accordingly, the DOM includes references to specific elements or nodes within the website page. To illustrate, DOM objects are part of a DOM tree structure, where each node of the DOM tree structure corresponds to a specific element in a website page.

In some embodiments, the autonomous software agent system 100 utilizes the large language model to perform an act of identifying relevant document object model elements (e.g., DOM elements). In particular, the autonomous software agent system 100 prompts the large language model to identify relevant DOM elements in the context of the prompt 502. In other words, the autonomous software agent system 100 utilizes the large language model to distill a website page into a relevant set of elements for the prompt 502.

In some embodiments, the autonomous software agent system 100 utilizes the large language model to generate a simplified DOM tree (e.g., a simplified document object model tree). As mentioned above, in some instances, a website page contains a large amount of data that can potentially bog down computational processes. As such, the autonomous software agent system 100 utilizes the large language model to extract the most salient/relevant elements from a website page (e.g., being browsed via the browser tool 510) and generates the simplified DOM tree.

In one or more embodiments, the simplified DOM tree refers to a distilled document object model structure and/or a distilled hierarchical representation of a webpage's content. In particular, the simplified DOM tree includes a hierarchy of nodes and elements from the website page that are relevant to the prompt 502. In other words, the simplified DOM tree contains fewer website page elements relative to an initially determined DOM tree from the website page.

In one or more embodiments, the autonomous software agent system 100 can obtain browser data from an autonomous software agent utilizing the browser tool 510. In particular, the autonomous software agent system 100 can obtain site cookies, access credentials submitted by a user computing device, complex navigations, time-based one-time passwords (e.g., multi-factor authentication) submitted by a user computing device. Furthermore, in some embodiments, the autonomous software agent system 100 can store the aforementioned web-based actions/inputs as part of a virtual machine snapshot. In some embodiments, the autonomous software agent system 100 can receive session cookies (e.g., web browser cached data or other web browser data) from a user computing device during setup of a virtual machine snapshot.

In some embodiments, the autonomous software agent system 100 utilizes the shell tool 508 to generate one or more terminal commands. In one or more embodiments, the shell tool 508 refers to one or more terminals (e.g., one or more terminal windows). In particular, the autonomous software agent system 100 deploys the autonomous software agent that can create new terminal windows or switch to different terminal windows, or delete terminals (e.g., which is how an autonomous software agent can run multiple processes at once). For relatively long commands, the autonomous software agent system 100 can use the autonomous software agent to shift its attention away from the long-running command and multitask in parallel (e.g., via the shell tool 508).

In some embodiments, the shell tool 508 is a text-based application where the autonomous software agent can input commands that interact directly with a computer's operating system. In particular, the autonomous software agent system 100 spins up the autonomous software agent that includes a shell application and in the shell application there are different terminals. As mentioned, where each terminal is like a single terminal window, the autonomous software agent system 100 (e.g., via the autonomous software agent) has the ability to create new terminals, switch to different terminal windows or delete terminals.

Furthermore, the autonomous software agent system 100 performs an act of utilizing the autonomous software agent to generate terminal commands. In one or more embodiments, a terminal command refers to text instructions to instruct a computer's operating system. In particular, a terminal command refers to one-line instructions that typically call upon existing programs of an operating system.

In some embodiments, a terminal command refers to text-based instructions submitted/inputted into a terminal (e.g., the terminal is an interface that allows computing devices such as the autonomous software agent to interact with a computer system's underlying operating system or run scripts and programs directly). To illustrate, terminal commands can include file and directory navigation, file operations, viewing file contents, searching and filtering, processes and systems in an operating system, determining permissions and ownerships in an operating system, and networking.

Moreover, the autonomous software agent system 100 generates command outputs. In one or more embodiments, command outputs refer to outputs that correspond with terminal commands submitted via the shell tool 508. To illustrate, a command output can include an absolute path (e.g., in response to a command to determine a location), tabular text (e.g., in response to a command to list files), raw file text (e.g., in response to a command to print file contents), an interactive viewer (e.g., in response to a command to provide a paged output), an output pattern (e.g., in response to a command to search/filter files in an operating system), and a file path (e.g., in response to a command to locate files).

Accordingly, the autonomous software agent system 100 utilizes the autonomous software agent to execute a software task (e.g., indicated by the prompt 502) by using the shell tool 508. In particular, the autonomous software agent system 100 determines a plurality of sub-tasks for a meta-task indicated in the prompt 502, generates an artificial intelligence plan, and utilizes the shell tool to execute one or more of the sub-tasks (e.g., by submitting terminal commands).

In some embodiments, the autonomous software agent system 100 receives a selection of a shell feature and opens/launches an interactive shell of the autonomous software agent. In particular, the autonomous software agent system 100 causes a graphical user interface (e.g., of a user computing device) to show shell activity (e.g., terminal commands or outputs corresponding to terminal commands) of the autonomous software agent utilizing the shell tool 508 while independently performing the software task. Accordingly, the user computing device (e.g., via the graphical user interface) can intervene (e.g., take over) the autonomous software agent's shell and push a software task in a different direction.

Accordingly, in one or more embodiments, the autonomous software agent system 100 can utilize the submitted terminal commands, the corresponding terminal command outputs, and/or user inputs (e.g., from a user computing device taking over the shell tool 508) and store them as a virtual machine state of an autonomous software agent. In particular, the autonomous software agent system 100 can store the inputs and outputs corresponding to the shell tool 508 as a virtual machine snapshot for an autonomous software agent at a specific point within a development session.

In one or more embodiments, the autonomous software agent system 100 utilizes an integrated development environment 512 to generate computer code in accordance with one or more embodiments. For example, the autonomous software agent system 100 accesses/receives a request and deploys an autonomous software agent. In particular, the autonomous software agent system 100 deploys the autonomous software agent to operate within an independent virtual machine computing environment.

Moreover, the autonomous software agent system 100 provides the integrated development environment 512 (IDE tool) to the autonomous software agent. In one or more embodiments, the integrated development environment 512 of the autonomous software agent includes an editor (e.g., in some embodiments, the autonomous software agent utilizes multiple editor tabs which represent open files in an editor area of the IDE for writing/editing computer code). In particular, the editor corresponds to an open file.

As mentioned above, the autonomous software agent has access to its own editor. In some embodiments, an editor refers to a software program or tool for writing or modifying computer code. In particular, an editor streamlines a computer code writing process by providing syntax highlighting, auto-completion, and error detection. For example, the editor provides color-coding for keywords, variables, functions, and other code elements. Further, for auto-completion, the editor suggests completions for variables, methods, classes, and functions.

In some embodiments, project files refer to a set of files and resources organized together to represent a specific software coding task (e.g., project). For example, the project files can include source code (e.g., program code written in a specific programming language), configurations (e.g., settings defining how a project is built, compiled, and executed), dependencies (e.g., external libraries), libraries, assets, and other components required to complete a software coding task.

In some embodiments, the autonomous software agent system 100 utilizes the integrated development environment 512 to perform an act of generating computer code. In some embodiments, computer code includes a set of instructions written in a programming language that a computing device can interpret and execute to perform a specific task. In particular, computer code includes a series of statements and functions that execute specific operations. Further, computer code includes statements written in specific syntax and translatable into machine code to be executed by a computing device.

Further, computer code can include function code and test code. In some embodiments, function code refers to a set of instructions written in a programming language that a computing device can interpret and execute to perform a specific task. Function code can include a series of statements and functions that define specific operations or processes performed by a computer upon execution of the code. In some cases, function code includes statements written in specific syntax and translatable into machine code to be executed by a computing device for performing one or more processes of an overall intent.

In some embodiments, test code refers to computer code that defines a function test for function code. For example, test code can include one or more code segments for determining that the function code satisfies an intent query. In some cases, the autonomous software agent system 100 utilizes test code to test function code. For example, the autonomous software agent system 100 generates the test code that includes computer code for testing whether the output of function code satisfies an intent query. In some embodiments, test code can also test for different types of errors (e.g., syntax errors and logic errors) and/or for hazardous or harmful function code.

In some embodiments, the computer code includes executable program code which refers to a set of instructions that a computing device can directly execute. In particular, executable program code includes machine-readable instructions that result from compiling high-level programming languages. In other words, executable program code refers to a final output for a software development process created by compiling source code.

As noted above, in one or more embodiments, the autonomous software agent system 100 provides actions performed by the autonomous software agent to a graphical user interface of a user (e.g., a user computing device). In particular, in the context of the integrated development environment 512, the autonomous software agent system 100 can provide to a graphical user interface real-time actions and/or actions performed during a development session of the autonomous software agent utilizing the integrated development environment 512.

In some embodiments, the autonomous software agent system 100 can receive an input selection that relates to a user computing device indicating a desire to modify one or more inputs in the integrated development environment 512. Further, in some embodiments, the autonomous software agent system 100 can receive an input selection to follow the autonomous software agent (e.g., in real-time) as the autonomous software agent executes a software task indicated by the prompt 502.

In some embodiments, the autonomous software agent system 100 provides for display the integrated development environment 512 that includes the above-mentioned editor tab. Further, in some instances, the autonomous software agent system 100 also provides a problems tab which lists errors, warnings, and information for computer code (in the editor tab) for a user to efficiently see errors in computer code or jump to problematic portions of computer code), an output tab (e.g., shows logs and messages from the IDE or extensions of the IDE to be notified of background activities like loading data onto a server or plugin operations), a debug console (e.g., allows for interactions with a program during debugging, such as viewing runtime logs, evaluating expressions, or inspecting variables), a terminal (e.g., a built-in shell/command-line interface for executing/submitting commands to a terminal, such as running scripts or installing packages), and a version control tab (e.g., provides information as to which devices submitted changes to a code repository and why the changes were submitted to a code repository).

Accordingly, in one or more embodiments, the autonomous software agent system 100 can utilize the written computer code within the integrated development environment 512, the corresponding outputs, and/or user inputs (e.g., from a user computing device taking over the integrated development environment 512) and store them as a virtual machine state of an autonomous software agent. In particular, the autonomous software agent system 100 can store the inputs and outputs corresponding to the integrated development environment 512 as a virtual machine snapshot for an autonomous software agent at a specific point within a development session.

Thus, FIG. 5 illustrates the autonomous software agent system 100 utilizing software composition tools to generate artificial intelligence output(s) 516 that are responsive to the prompt 502. In particular, FIG. 5 illustrates the autonomous software agent system 100 switching between the shell tool 508, the browser tool 510, the integrated development environment 512, and/or the planner tool 514 to generate the artificial intelligence output(s) 516. In particular, the autonomous software agent system 100 switches between the various software composition tools while operating within a custom software development environment as indicated by a virtual machine snapshot.

More specifically, in one or more embodiments, the autonomous software agent system 100 is configured to automatically (e.g., without further user instructions other than the prompt defining the software task) perform an assigned software task using coordinated interaction among planner tool 514, browser tool 510, an integrated development environment (IDE) 512, a shell tool 508, and an independent virtual machine computing environment. For example, upon receiving a software task—expressed in natural language, structured specification, source code fragment, test case, or other machine-interpretable format—the autonomous software agent system 100 provides the software task to planner tool 514. The planner tool 514 analyzes the objective and generates a structured execution plan comprising an ordered set of subtasks, dependency relationships, required tools, expected outputs, and validation criteria. The execution plan may define actions such as retrieving documentation, generating source code, creating files, compiling code, executing tests, debugging failures, refactoring modules, or deploying artifacts. The autonomous software agent system 100 executes the structured plan within the independent virtual machine computing environment. Where plan steps require external information or dependency retrieval, the autonomous software agent system 100 invokes the browser tool 510 within the independent virtual machine computing environment. The autonomous software agent system 100 uses the browser tool 510 to retrieve and parse remote documentation, API specifications, repositories, or other network-accessible resources and returns structured, machine-readable representations to autonomous software agent system 100 for reasoning and code synthesis.

For code authoring and modification operations, the autonomous software agent system 100 interacts with the IDE 512. The IDE 512 enables creation, editing, refactoring, and organization of source files, as well as invocation of compilers, interpreters, build systems, static analysis tools, and test frameworks. The IDE 512 provides structured diagnostics, including syntax errors, semantic warnings, dependency conflicts, and build logs, which are returned to autonomous software agent system 100. Where system-level commands are required, autonomous software agent system 100 issues instructions through the shell tool 508 executing within the independent virtual machine computing environment. The shell tool 508 enables file system manipulation, dependency installation, build execution, test invocation, process control, and other operating system-level operations. Structured outputs including exit codes, logs, and error streams are returned to autonomous software agent system 100.

The planner tool 514, in one or more implementations, monitors intermediate results generated by the IDE 512, browser tool 510, and shell tool 508, and compares those results against plan-defined success criteria. If discrepancies, failures, or unexpected states are detected, the planner tool 514 automatically revises the execution plan, generates corrective subtasks, reorders actions, or initiates debugging procedures. This iterative loop continues until the software task satisfies defined completion conditions or termination criteria. In this manner, autonomous software agent system 100 autonomously decomposes, executes, validates, and refines development actions within the independent virtual machine computing environment using coordinated tool invocation and structured feedback processing. The integration of planner tool 514, browser tool 510, the 512, the shell tool 508, and the independent virtual machine computing environment enables end-to-end automated software development, testing, and validation without direct human intervention.

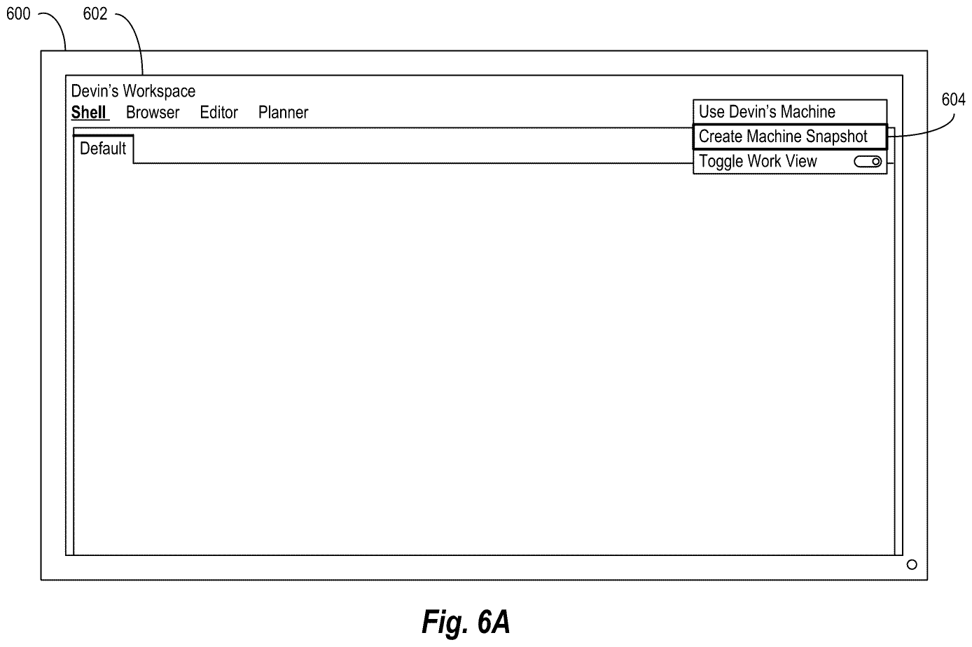

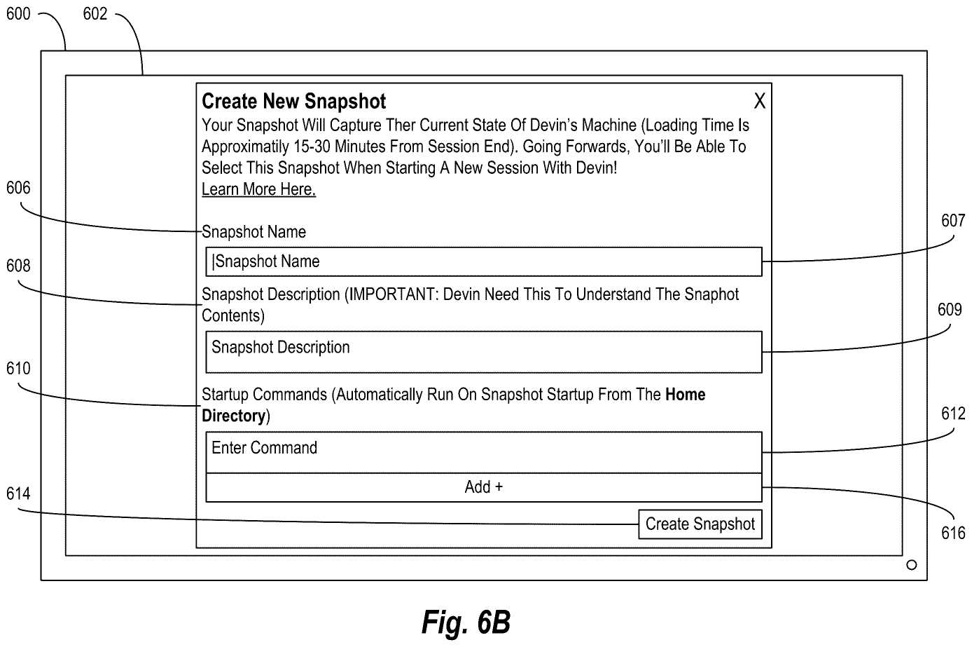

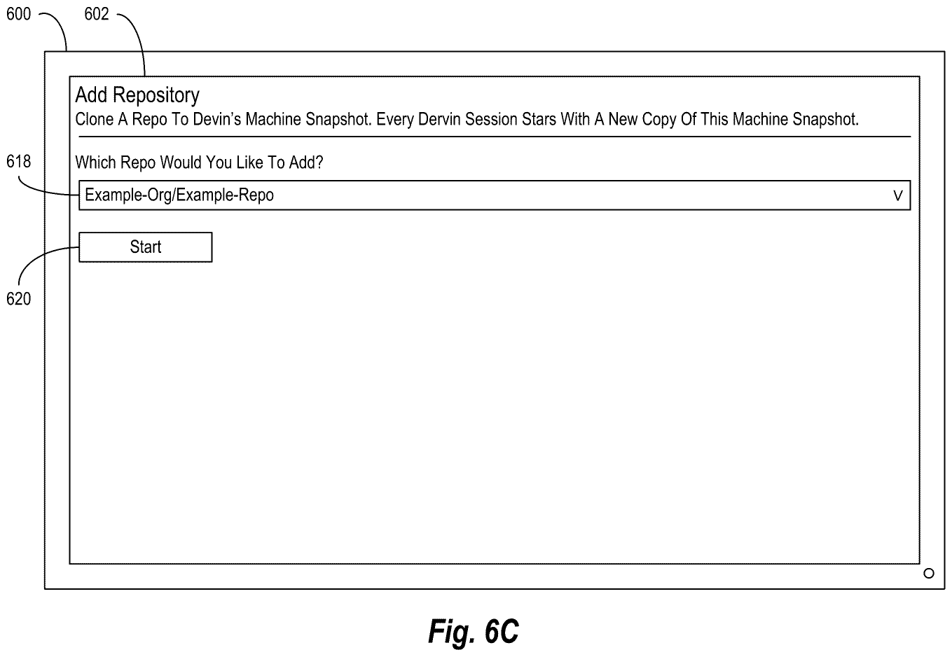

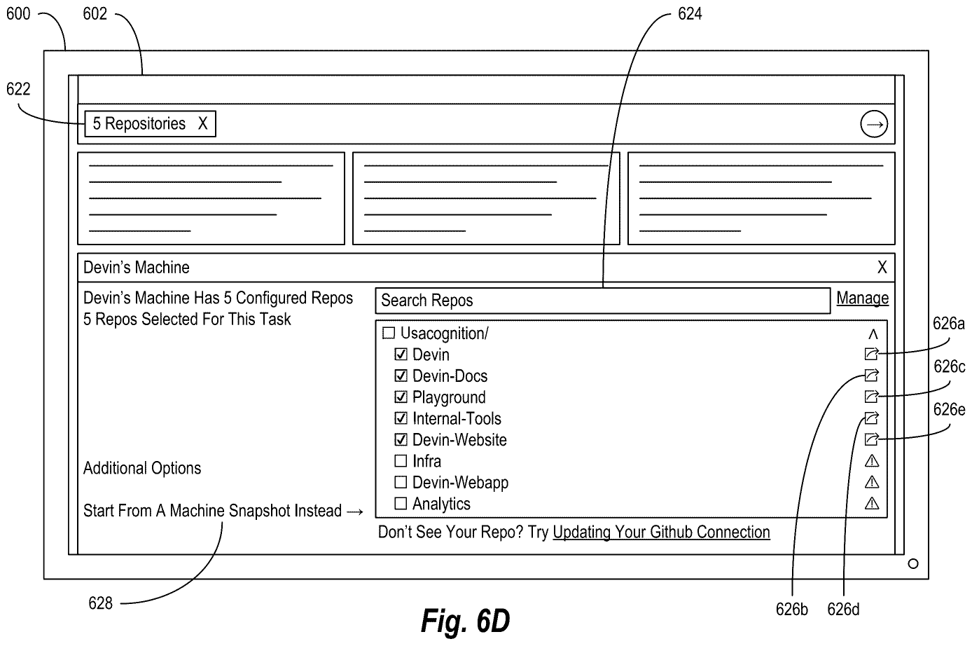

FIG. 6A shows the autonomous software agent system 100 providing a virtual machine snapshot interface in accordance with one or more embodiments. For example, FIG. 6A shows a graphical user interface 602 of a user computing device 600 displaying a virtual machine snapshot interface for configuring an autonomous software with a custom software development environment. As mentioned above, the autonomous software agent system 100 deploys an autonomous software agent with a selected custom software development environment (e.g., indicated by a selected virtual machine snapshot). In particular, FIG. 6A shows a create machine snapshot element 604.

FIG. 6B shows the autonomous software agent system 100 capturing a current machine state of an autonomous software agent in accordance with one or more embodiments. For example, FIG. 6B shows a snapshot name element 606 with a corresponding snapshot name input element 607. In particular, the snapshot name element 606 allows the user computing device 600 to provide a custom name for a snapshot. Furthermore, FIG. 6B shows a snapshot description element 608 and a snapshot description input element 609. In particular, the snapshot description element 608 allows the user computing device 600 to provide context, tips, guidance, and instructions for the snapshot.

Moreover, FIG. 6B shows a startup command element 610 and a startup command input element 612. In particular, the startup command element 610 allows the user computing device 600 to indicate one or more startup commands for an autonomous software agent to automatically run (e.g., in response to selecting the created snapshot) upon starting/initializing a development session. Further, FIG. 6B shows an additional startup command element 616 to add additional startup commands.

Additionally, FIG. 6B shows a create snapshot element 614. In some embodiments, in response to a selection of the create snapshot element 614, the autonomous software agent system 100 captures a current state of an autonomous software agent's machine executing a software task. Further, in some embodiments, the autonomous software agent system 100 kills a current development session and any hosted services of the autonomous software agent in response to a selection of the create snapshot element 614.

Furthermore, FIG. 6C shows an option to add a code repository to a virtual machine snapshot in accordance with one or more embodiments. For example, FIG. 6C shows an add repository element 618. In particular, the add repository element 618 includes a drop-down list of different code repositories to clone and make part of a virtual machine snapshot. For example, a selection of a specific code repository causes the autonomous software agent system 100 to start up a development session according to a selected virtual machine snapshot with a copy of the selected code repository. Moreover, FIG. 6C shows a start element 620 to add the repository selected from the add repository element 618.

FIG. 6D shows the autonomous software agent system 100 providing an option for the user computing device 600 to configure code repositories for a development session of an autonomous software agent in accordance with one or more embodiments. For example, FIG. 6D shows a code repository selection 622 of five code repositories. In particular, FIG. 6D shows an option 624 to search code repositories and a first code repository 626a, a second code repository 626b, a third code repository 626c, a fourth code repository 626d, and a fifth code repository 626e selected as part of the code repository selection 622. Moreover, FIG. 6D shows a machine snapshot element 628 that allows the user computing device 600 to start from a virtual machine snapshot instead of manually selecting each relevant code repository.

FIG. 7A shows the autonomous software agent system 100 providing an option to configure a virtual machine snapshot. For example, FIG. 7A shows a graphical user interface 702 of a user computing device 700 to configure a virtual machine snapshot. In some embodiments, configuring the virtual machine snapshot allows the autonomous software agent system 100 to start a new development session with the configured virtual machine snapshot (e.g., rather than taking a snapshot of a current development session).

FIG. 7A shows an add repository element 704 to add a code repository to a virtual machine snapshot. Furthermore, FIG. 7A shows a remove repository element 706 to remove a code repository from a virtual machine snapshot. Moreover, FIG. 7A shows a modify repository setup 708 to change configuration settings of an added code repository. Additionally, FIG. 7A shows a repository modify element 710 with a dropdown menu to select a specific code repository to modify. Moreover, FIG. 7A shows a start element 712 to begin the process of configuring the virtual machine snapshot.

FIG. 7B shows a continue repository setup element 714 to continue editing configuration/setup options for a code repository of a virtual machine snapshot. For example, FIG. 7B can include a startup command element 716 with a first startup command 724 to pull the latest from a code repository. Additionally, FIG. 7B shows an add startup command element 726 to add another startup command for instructions to pull the latest repository. Moreover, FIG. 7B shows an update dependencies element 718 with a second startup command 728 that can relate to updating dependencies. Additionally, FIG. 7B shows an add startup command element 730 for additional instructions to update dependencies.

FIG. 7B further shows a knowledge element 720 to add knowledge elements to a virtual machine snapshot. Moreover, the knowledge element 720 can include a test 732 to run Lint (e.g., a quality check on computer code) within a code repository. Additionally, FIG. 7B shows an add knowledge element 733 to add additional instructions regarding running different tests. Moreover, FIG. 7B shows a run unit tests element 722 and a first unit test 734 and a second unit test 736 for the run unit tests element 722. Moreover, FIG. 7B shows an add unit test element 738 to add additional instructions for running additional unit tests.

In one or more embodiments, the autonomous software agent system 100 receives access to a code repository as part of receiving a virtual machine snapshot configuration. In some embodiments, the autonomous software agent system 100 receives access to a code repository and generates artificial intelligence setup suggestions to surface via the graphical user interface 702 of the user computing device 700. For example, the autonomous software agent system 100 can generate a code repository pull suggestion, which refers to a command for an autonomous software agent to pull recent changes from a code repository.

In some embodiments, the autonomous software agent system 100 can generate an access credential suggestion for requesting secrets or environment variables to operate within the code repository. In some embodiments, the autonomous software agent system 100 can generate an install dependency suggestion for requesting code dependencies to operate within the code repository. Further, in some embodiments, the autonomous software agent system 100 can generate a software test suggestion for testing computer code within the code repository.

In one or more embodiments, the autonomous software agent system 100 generates artificial intelligence suggestions for each step of configuring a virtual machine snapshot. In particular, the autonomous software agent system 100 can generate the artificial intelligence suggestions based on an analysis of a code repository (e.g., selected by the user computing device 700).

To illustrate, the autonomous software agent system 100 can generate a plurality of artificial intelligence suggestions as part of setting up a code repository as part of a virtual machine snapshot. In particular, the autonomous software agent system 100 can sequentially provide different artificial intelligence suggestions, such as code repository pull suggestions, access credential suggestions, install dependency suggestions, software test suggestions (e.g., Lint tests and functional tests), local application tests, and additional suggested instructions for an autonomous software agent (e.g., based on an analysis of a code repository part of a virtual machine snapshot).

Additionally, in some embodiments, the autonomous software agent system 100 can prompt the user computing device 700 to accept or reject each generated artificial intelligence suggestion. Moreover, in some embodiments, the autonomous software agent system 100 allows the user computing device 700 to individually modify each generated artificial intelligence suggestion. In some embodiments, the autonomous software agent system 100 provides options for the user computing device 700 to save a currently configured virtual machine snapshot to finish the setup at a later point in time.

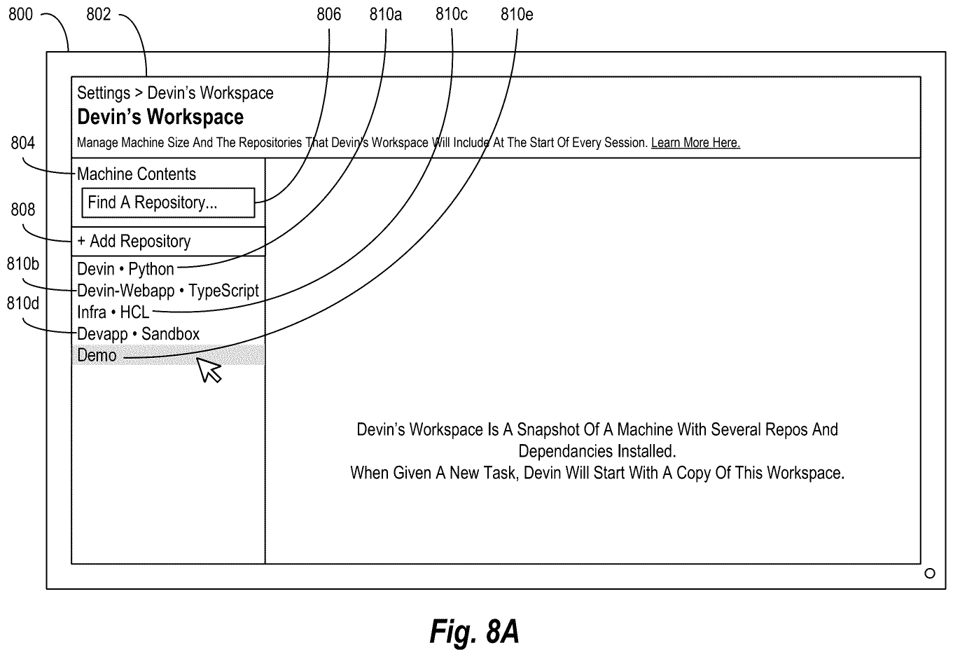

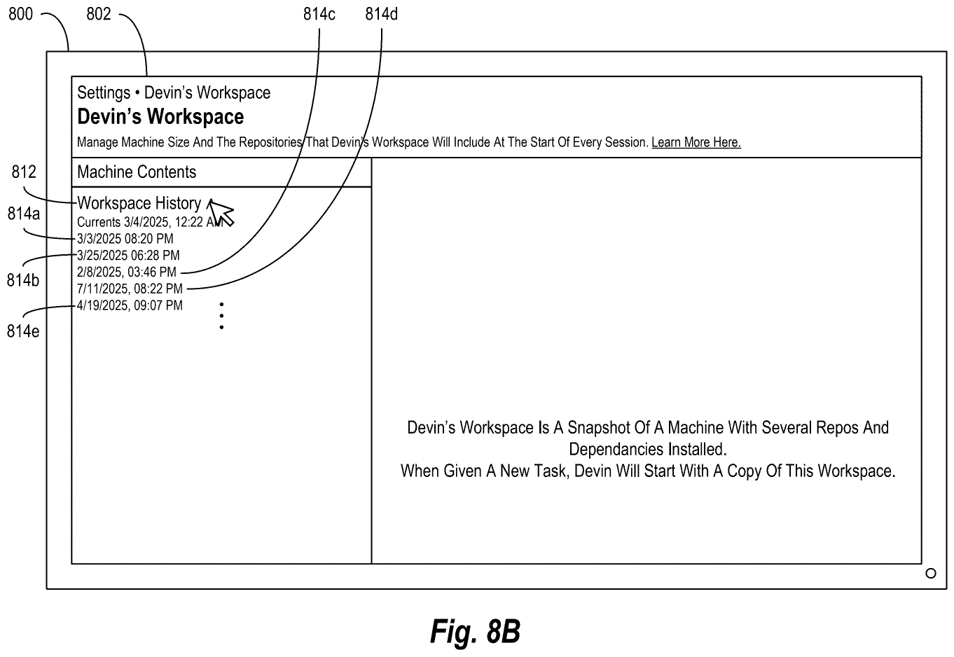

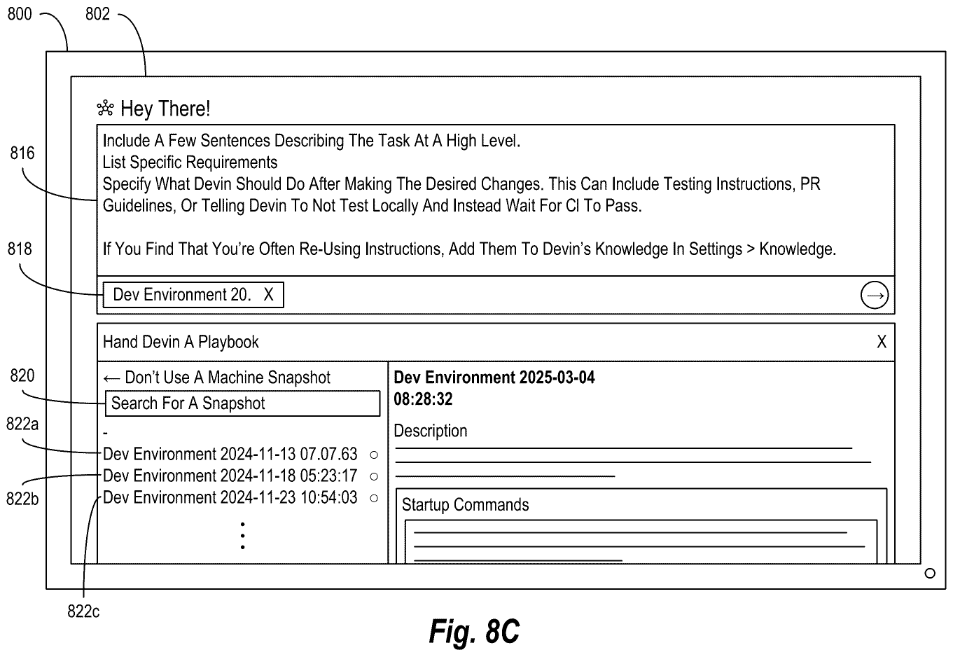

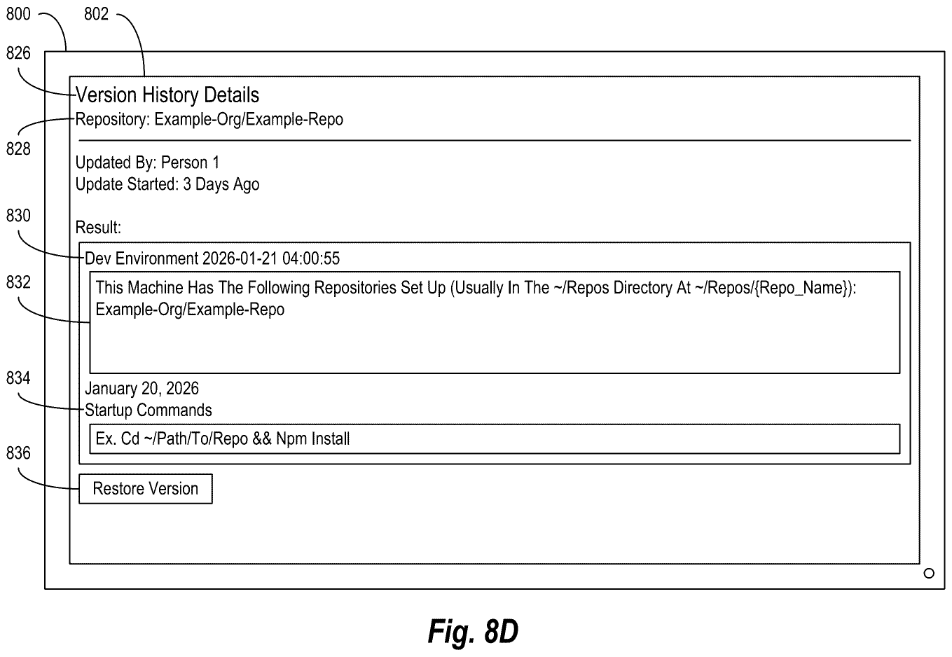

FIG. 8A shows the autonomous software agent system 100 providing for display on a graphical user interface 802 of a user computing device 800 a workspace to select a code repository to provide to an autonomous software agent for executing a software task. For example, FIG. 8A shows a machine contents element 804, a search repository element 806, and an add repository element 808. In particular, FIG. 8A shows a first code repository 810a, a second code repository 810b, a third code repository 810c, a fourth code repository 810d, and a fifth code repository 810e. In other words, FIG. 8A shows how the user computing device 800 can configure the machine contents of an autonomous software agent.

FIG. 8B shows a workspace history element 812 (e.g., version history). For example, FIG. 8B shows a first virtual machine snapshot 814a, a second virtual machine snapshot 814b, a third virtual machine snapshot 814c, a fourth virtual machine snapshot 814d, and a fifth virtual machine snapshot 814e. In particular, a selection of one of the versions from the workspace history element 812 allows the autonomous software agent system 100 to configure a software development environment of an autonomous software agent with the selected version.

FIG. 8C shows a chat interface of the user computing device 800. In particular, FIG. 8C shows a chat input element 816 for the user computing device 800 to interact with the autonomous software agent system 100. Moreover, FIG. 8C shows an environment selection element 818 to select an environment for deploying an autonomous software agent. In addition, FIG. 8C shows a search snapshot element 820, a first virtual machine snapshot 822a, a second virtual machine snapshot 822b, and a third virtual machine snapshot 822c. In particular, in response to selecting one of the virtual machine snapshots, the autonomous software agent system 100 can deploy the autonomous software agent according to the selected virtual machine snapshot.

FIG. 8D shows a version history details element 826 with a relevant repository 828 (e.g., example-org/example-repo). Moreover, FIG. 8D shows relevant information such as when the repository was last updated and when the update started. Additionally, FIG. 8D shows results such as a development environment 830, details 832 (e.g., this machine has the following repositories set up, usually in the ~/repos directory at ~/repos/rpeos/{repo_name}): Example-Org/Example-Repo). Moreover, FIG. 8D shows a startup commands element 834 to specify startup commands for the machine state. Additionally, the autonomous software agent system 100 shows a restore version element 836 to restore the selected version as the virtual machine snapshot for an autonomous software agent.

In one or more embodiments, the autonomous software agent system 100 provides different options for the user computing device 800 to set up a custom virtual machine computing environment for different use cases. In some embodiments, the autonomous software agent system 100 can provide an option to configure a custom virtual machine computing environment for different code repositories. For example, for two different code repositories that require different environments, the autonomous software agent system 100 can install two different versions within a custom virtual machine computing environment of an autonomous software agent to operate within the two different code repositories.

Likewise, in some embodiments, the autonomous software agent system 100 provides different options for the user computing device 800 to set up environment variables for different code repositories. In particular, the autonomous software agent system 100 can access the above-discussed shell tool to run a terminal command to load the relevant environment variables for a relevant code repository (e.g., while an autonomous software agent is working within a specific code repository).

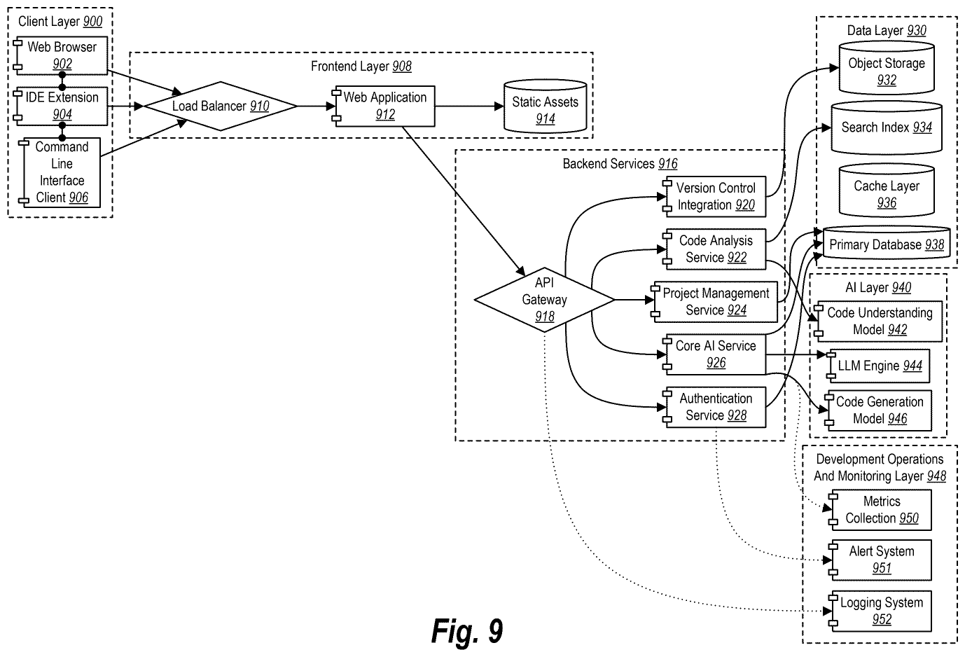

FIG. 9 illustrates architectural details of the autonomous software agent system 100 using one or more machine learning models in accordance with one or more embodiments. In particular, the autonomous software agent system 100 deploys an autonomous software agent with a plurality of computer software composition tools, generates one or more artificial intelligence outputs responsive to a software task, and provides responses to prompts submitted via an interface.

As shown in FIG. 9, the autonomous software agent system 100 contains a client layer 900 (e.g., with a web browser 902, an IDE extension 904, and a command line interface client 906), a frontend layer 908 with a load balancer 910 (e.g., which is a system to distribute incoming traffic across multiple servers which optimizes efficiency), a web application 912 (e.g., a Devin web application that shows a chat interface and the fully featured software composition tools of the autonomous software agent), and static assets 914 (e.g., files that do not dynamically change based on user interactions, such as HTML files, CSS files, JavaScript files, images, etc.).

Moreover, FIG. 9 shows the autonomous software agent system 100 also contains backend services 916 with an API gateway 918 (e.g., which is a single entry point for managing and routing API requests from client devices to different microservices/backend systems), a version control integration 920 (e.g., a backend service application to track changes to code such as a connected code repository application part of a code repository management system), a code analysis service 922, a project management service 924 (e.g., a software system to track the development of various tasks that a software development team is working on), a core AI service 926 (e.g., artificial intelligence modules or tools to handle the use of machine learning models, natural language processing, and other artificial intelligence tasks), and an authentication service 928 (e.g., to check for valid authentication credentials).

In particular, the backend services 916 include applications that all communicate with the backend web-server of the autonomous software agent system 100, which performs the job of deploying autonomous software agents, and orchestrating/managing sessions (Devin sessions), as well as providing the APIs to display data about the autonomous software agent system 100 on various computing devices, generating artificial intelligence outputs, orchestrating the execution of software tasks by accessing a plurality of software composition tools, providing a plurality of interactive tools to a user computing device. In particular, the backend services 916 of the autonomous software agent system 100 manage the generation of artificial intelligence outputs for executing a software task of a development session.

For example, the backend services 916 perform the job of enabling request decomposition, artificial intelligence plan generation, terminal command generation, computer code generation, navigation actions, software task orchestration, and interactive tools of the autonomous software agent. In particular, the client layer 900, the frontend layer 908 and the backend services 916 are in consistent communication with one another to notify each service regarding any input received from a user computing device (e.g., via a chat interface and/or user intervention via interactive tools). Thus, this enables the autonomous software agent system 100 to immediately transfer that input/context to a deployed autonomous software agent.

Further, FIG. 9 shows a data layer 930 with object storage 932 (e.g., which is storage of unstructured data), a search index 934 (e.g., an index of one or more code repositories), a cache layer 936 (e.g., a layer that temporarily holds frequently accessed or recently computed data), and a primary database 938 (e.g., a central data store to hold application data). Moreover, FIG. 9 shows an AI layer 940 with a code understanding model 942, an LLM engine 944, and a code generation model 946. Moreover, FIG. 9 shows a development operations and monitoring layer 948 (e.g., with metrics collection 950, an alert system 951, and a logging system 952).

As shown in FIG. 9, the autonomous software agent system 100 utilizes the AI layer 940 to perform a variety of reasoning/generation tasks. In particular, the autonomous software agent system 100 accesses the AI layer 940 every time a code repository is connected or updated, or a new session is spun up (e.g., each time a new development box is activated). In order to enable the AI layer 940, the autonomous software agent system 100 provides various onboarding tools to a user computing device. In particular, the onboarding tools allow a user to provide access to a code repository provider (e.g., a Gitprovider), select repositories, assign read access, and assign write access.

In some embodiments, the autonomous software agent system 100 prompts a user computing device for additional access permissions. In particular, the autonomous software agent system 100 can prompt the user for additional access permissions after generating a response to a prompt or during an autonomous software agent session. For example, the autonomous software agent system 100 determines during generating a response or executing software coding tasks that additional knowledge/permissions are needed to more thoroughly respond/perform a task.

As further shown in FIG. 9, the AI layer 940 of the autonomous software agent system 100 further includes the code understanding model 942. In particular, the code understanding model 942 analyzes computer code. In other words, the autonomous software agent system 100 seeks to understand the context and background of a code base/repository to generate an index of the code repository (e.g., to more effectively perform software coding tasks as a driver and not merely as a co-pilot).

In some embodiments, the autonomous software agent system 100 extracts contextual data from information provided by a user to generate an index using the code understanding model 942. To illustrate, the autonomous software agent system 100 parses through a code repository and generates abstraction summaries using the code understanding model 942 and one or more additional artificial intelligence models (e.g., such as the LLM engine).

Moreover, the autonomous software agent system 100 utilizes the AI layer 940 to enable AI-native features in a planner interface, a chat interface, or a configuration interface of an autonomous software agent. In particular, the autonomous software agent system 100 provides the AI-native features as options for a user computing device to activate during configuration or during interaction with the autonomous software agent system 100.

In some embodiments, the autonomous software agent system 100 uses the AI layer 940 to ingest data from a code base and further utilizes the code understanding model 942 to generate output predictions related to the context of the code base. For example, the autonomous software agent system 100 connects to code repositories and creates knowledge inputs/suggestions based on processing the information in the code repository.

To illustrate, the autonomous software agent system 100 can read through documentation/specifications and distill that information into data that is relevant for the code understanding model 942 of the autonomous software agent system 100. In addition, after generating the index of the code repository, the autonomous software agent system 100 further stores the index in the data layer 930 and/or uses the development operations and monitoring layer 948 to monitor changes/thresholds related to the connected code repository. This allows the autonomous software agent system 100 to more effectively execute software coding tasks when deploying an autonomous software agent.

Moreover, after generating the index of the code repository, the autonomous software agent system 100 further generates a response to prompts. In some embodiments, the autonomous software agent system 100 receives prompts from the frontend layer 908 submitted via an interface (or where the autonomous software agent system 100 intakes a prompt, whether via the web application, a messaging application, or otherwise) and are sent to the backend services 916 of the autonomous software agent system 100, where the prompt is processed by the one or more artificial intelligence components (e.g., Devin's brain).

As shown in FIG. 9, the autonomous software agent system 100 utilizes the client layer 900 to receive interactions. In particular, users can submit a prompt of a question regarding a current development session, past development session, a code repository, etc. via a Devin messaging application integration, an application programming interface call, or directly through a web browser application of the intelligent search interface. In some embodiments, the messaging application integration lets users prompt the autonomous software agent system 100 and to further create sessions by tagging an autonomous software agent in their team's messaging server.

As just mentioned, the messaging application integration allows for development sessions to be created by tagging/mentioning an autonomous software agent. In some embodiments, the autonomous software agent system 100 receives from a third-party messaging application between a plurality of users, a mention that tags the autonomous software agent to execute the software task. Additionally, the autonomous software agent system 100 transmits the mention that tags the autonomous software agent to a virtual private cloud that hosts the independent virtual. This is shown in more detail below.

In some embodiments, as shown, the autonomous software agent system 100 utilizes the LLM engine 944 (e.g., a model that selects one or more large language models according to certain parameters/requirements) of an autonomous software agent to generate a response to a prompt. In particular, the autonomous software agent system 100 calls a first large language model for a first task (e.g., generating a first result for a prompt) and a second large language model for a second task (generating a second result for the prompt).

In one or more embodiments, the autonomous software agent system 100 utilizes the complex architectural design shown in FIG. 9. In particular, the autonomous software agent system 100 includes a natural language processing component (e.g., Devin's Brain) that allows the autonomous software agent system 100 to understand natural language descriptions (e.g., the functionalities of desired software programs). In some embodiments, the autonomous software agent system 100 utilizes natural language processing to analyze natural language descriptions in a prompt and to extract key functionalities and requirements.

In one or more embodiments, the autonomous software agent system 100 generates an index of a code repository (e.g., accessible by an autonomous software agent) as described in application Ser. No. 19/224,222 PROVIDING INTELLIGENT SEARCH FUNCTIONALITY OF A CODE REPOSITORY VIA AN AUTONOMOUS SOFTWARE AGENT which was filed on May 30, 2025, and is fully incorporated by reference herein.

As mentioned above, in some embodiments, the autonomous software agent system 100 generates a response to the prompt and uses the context from the response to deploy an autonomous software agent. In some embodiments, the autonomous software agent system 100 uses the autonomous software agent system 100 to spin up a development box, where each spun up development box contains knowledge and the autonomous software agent system from one session to another does not transfer the knowledge over to the next session. In some embodiments, knowledge is a form of “memory” that allows the autonomous software agent system 100 to retrieve information based on specific triggers that might be relevant to the session. As also mentioned, this knowledge (depending on the trigger) is retrievable across all sessions.

As mentioned above, the autonomous software agent system 100 uses the autonomous software agent system 100 which deploys autonomous software agents that have access to their own machines. In particular, for each new spun up session, the autonomous software agent system 100 spins up a new development box (e.g., sandbox) which includes a fully featured IDE (shell, an editor, a bowser, etc.). Moreover, the autonomous software agent system 100 allows a development box to be customized in a user's workspace (e.g., Devin's Workspace), where the user can save a specific machine snapshot that the autonomous software agent system 100 will use each time it spins up a new development box.

Furthermore, the autonomous software agent system generates development boxes that are isolated virtual machines. In particular, the development boxes run on top of a custom hypervisor implemented to support the virtual machine technology. Moreover, the state of a run (e.g., deploying an autonomous software agent) can be rolled-back to an earlier point in time. In rolling back to an earlier point in time, the autonomous software agent system 100 rolls back both the state of “Devin's brain” (e.g., the knowledge and the progress on a certain task), as well as the state of Devin's machine (e.g., the machine contents).

Moreover, in some embodiments, the autonomous software agent system 100 offers a virtual private cloud (VPC) deployment solution that allows development boxes to run within a customer's (a set of users) cloud tenant with the “Devin brain” (e.g., a component of the autonomous software agent) interacting with the development boxes over a secure tunnel. All data related to sessions are stored at rest in the customer cloud tenant.

Furthermore, each of these development boxes (or sessions) can speak to the customer-hosted services (connected via API integrations). Accordingly, the autonomous software agent system 100 can leverage the AI layer 940, the data layer 930, the backend services 916, and the frontend layer 908 to cause the graphical user interface on the user computing device to display the actions taken by the autonomous software agent (e.g., the actions via the software composition tools of the autonomous software agent).

Further, as already mentioned, the autonomous software agent system 100 includes machine learning models. In particular, the autonomous software agent system 100 utilizes pre-trained machine learning models to translate descriptions (e.g., from a response to a prompt) into artificial intelligence outputs (e.g., artificial intelligence plans, computer code, terminal commands, navigation actions, etc.). Moreover, the machine learning models utilized by the autonomous software agent system 100 have been trained on vast amounts of computer code data, which allows them to identify patterns and generate functional code. In some embodiments, the autonomous software agent system 100 utilizes the machine learning models to process the extracted information (e.g., key functionalities and requirements). In particular, the autonomous software agent system 100 utilizes the machine learning models to search for patterns and identify similar code structures from their training data.

Additionally, the autonomous software agent system 100 includes the code generation model 946. In particular, based on processed information from the natural language processing and the machine learning models, the autonomous software agent system 100 translates the descriptions into actual computer code. In other words, the output of the natural language processing and the machine learning model is pulled into the code generation engine to create viable computer code. In some embodiments, based on identified patterns, the autonomous software agent system 100 utilizes the code generation engine to create functional code responsive to deploying an autonomous software agent after generating a response to a prompt.

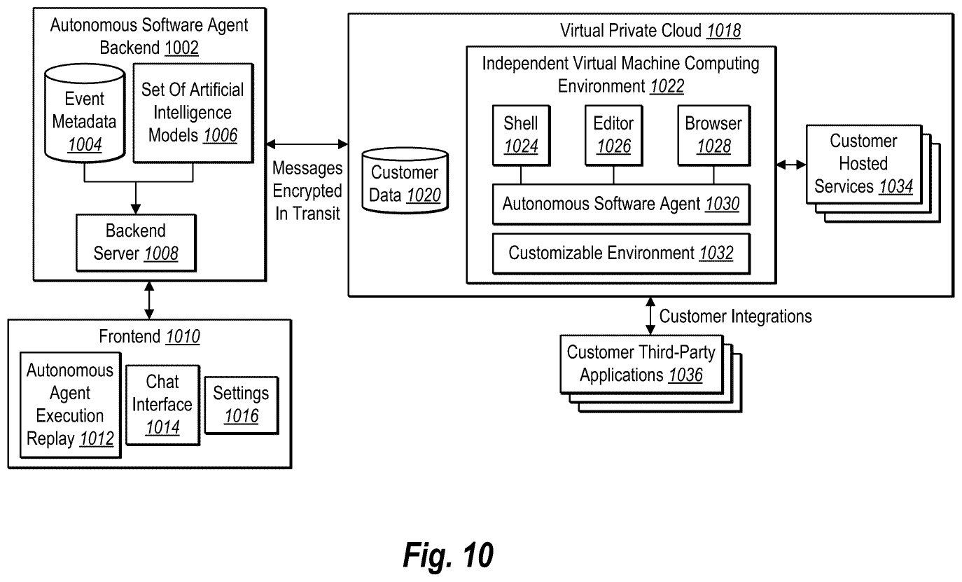

FIG. 10 illustrates additional details of the architecture of the autonomous software agent system 100 in accordance with one or more embodiments. For example, FIG. 10 shows that for each session of deploying an autonomous software agent, the autonomous software agent system 100 spins up/deploys an autonomous software agent backend 1002 that includes a “backend container” paired with “a development box” virtual machine. In other words, the autonomous software agent system 100 initializes a development box (e.g., an independent virtual machine computing environment) with an autonomous software agent backend that includes a set of artificial intelligence models 1006. As mentioned above, the set of artificial intelligence models 1006 contains one or more machine learning/artificial intelligence models shown above used to process, analyze, and generate data.

As shown in FIG. 10, the autonomous software agent backend 1002 includes event metadata 1004 (e.g., context surrounding a prompt/request submitted to a web application interface, a response to the prompt, or other external sources that contain contextual data), the set of artificial intelligence models 1006 (e.g., one or more machine learning models shown and discussed in FIG. 9), and a backend server 1008 (e.g., a server that handles logic, database interactions, authentication, and other services for deploying an autonomous software agent).

Further, FIG. 10 shows the autonomous software agent backend 1002 interacting with a frontend 1010 which includes autonomous agent execution replay 1012 (e.g., replay for a timelapse of a development session, a session replay that is a recording of previous user interactions with the autonomous software agent system 100), chat UI 1014 (e.g., the graphical user interface provided to a user to submit prompts), and settings 1016 (e.g., custom settings established by the autonomous software agent system 100 or by a user).

Moreover, the autonomous software agent backend 1002 communicates with a virtual private cloud 1018 (e.g., a customer virtual private cloud, which is a dedicated and isolated virtual network within a public cloud service) via encrypted messages. In particular, FIG. 10 shows an independent virtual machine computing environment 1022 hosted on the virtual private cloud 1018 and the virtual private cloud 1018 further includes customer data 1020.

Additionally, the independent virtual machine computing environment 1022 further includes a shell 1024, an editor 1026 (e.g., integrated development environment), a browser 1028, an autonomous software agent 1030, a customizable environment 1032 (e.g., playbooks, knowledge, etc. that customize an independent virtual machine computing environment) and customer hosted services 1034 (e.g., services or applications hosted and managed by a tenant organization). Additionally, FIG. 10 shows that the virtual private cloud 1018 can integrate various applications via access tokens/API keys. In particular, the autonomous software agent system can use the independent virtual machine computing environment 1022 (e.g., the autonomous software agent) to write various code and make integrations with applications integrated with the virtual private cloud 1018 (e.g., customer third-party applications 1036).

In one or more embodiments, the autonomous software agent system 100 utilizes a communication between the virtual private cloud 1018 and the autonomous software agent backend 1002 (e.g., that includes the set of artificial intelligence models 1006) to transmit (e.g., encrypted communications) a sub-task of a software task. In particular, in the context of the above discussion, the autonomous software agent system 100 transmits the sub-task to the autonomous software agent backend 1002 to determine a current software development environment, a current sub-task, a timestamp, an artificial intelligence suggestion for a user computing device, a prompt for the user computing device to restore a certain virtual machine snapshot, and/or a prompt for the user computing device to save a current state of an autonomous software agent. Accordingly, a development session involves the autonomous software agent system 100 leveraging the independent virtual machine computing environment 1022 paired with the autonomous software agent backend 1002.

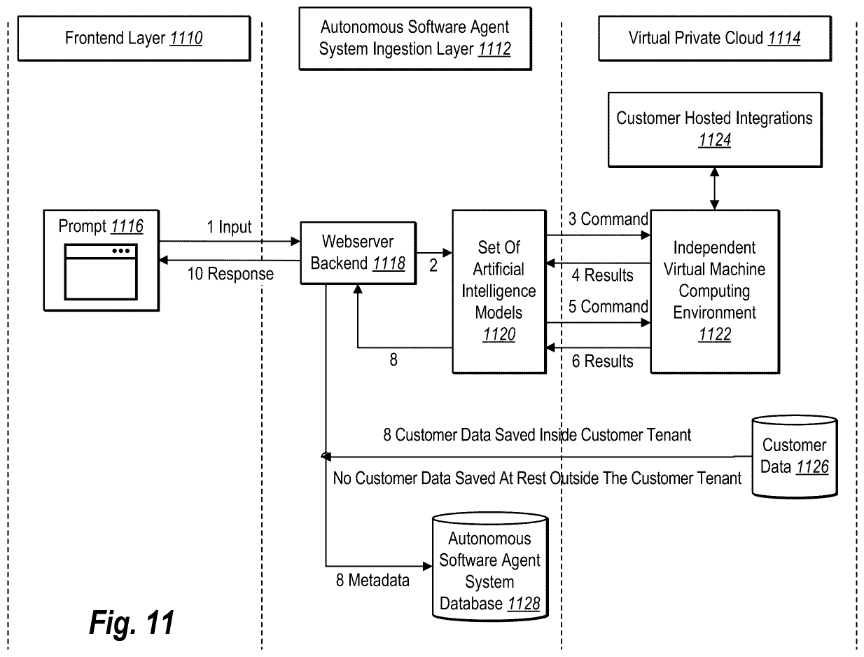

Further, FIG. 11 shows that the autonomous software agent system 100 receives a prompt 1116 via a frontend layer 1110. As shown, the autonomous software agent system 100 passes the prompt 1116 to an autonomous software agent system ingestion layer 1112. In response to the prompt 1116, the autonomous software agent system 100 responds to the prompt 1116 with a webserver backend 1118 and further passes the information to a set of artificial intelligence models 1120 (e.g., one or more artificial intelligence models shown above in FIG. 9).

As further shown in FIG. 11, the autonomous software agent system 100 passes commands/results back and forth between a virtual private cloud 1114 (e.g., an independent virtual machine computing environment 1122) and the set of artificial intelligence models 1120. In other words, FIG. 11 illustrates the interaction between the frontend layer 1110 of the autonomous software agent system 100, the backend of the autonomous software agent system 100, and an autonomous software agent deployed for performing tasks at the virtual private cloud 1114. Furthermore, the independent virtual machine computing environment 1122 also accesses customer hosted integrations 1124 at the virtual private cloud 1114.

Additionally, FIG. 11 shows customer data 1126 at the virtual private cloud 1114 which the autonomous software agent system 100 passes all customer data saved inside the customer tenant to the tenant (e.g., and no customer data is saved at rest outside the customer tenant). Moreover, FIG. 11 shows the autonomous software agent system 100 using the webserver backend 1118 to pass metadata to an autonomous software agent system database 1128.

In one or more embodiments, the autonomous software agent system 100 receives an autonomous software agent prompt and deploys an autonomous software agent, which includes one or more machine learning components (e.g., large language models). In one or more embodiments, the autonomous software agent system 100 utilizes a text encoder to generate a set of text tokens for the autonomous software agent prompt.

Moreover, based on the text tokens, the autonomous software agent system 100 generates an artificial intelligence plan (e.g., breaks down the software task), and further reasons how to complete one or more tasks. In particular, the autonomous software agent system uses the independent virtual machine computing environment 1122 to communicate with the set of artificial intelligence models 1120 (e.g., the artificial intelligence components shown in FIG. 9) to determine which shell commands to make, computer code to write (e.g., in the editor), and webpages to browse.

In one or more embodiments, the autonomous software agent system 100 further utilizes a text encoder to process a prompt/request to deploy an autonomous software agent. In particular, the text encoder includes a component of a neural network to transform textual data (e.g., the text prompt) into a numerical representation. For instance, the autonomous software agent system 100 utilizes the text encoder to transform the prompt into a text encoding (e.g., text tokens). Further, the autonomous software agent system 100 utilizes the text encoder in a variety of ways.

For instance, the autonomous software agent system 100 utilizes the text encoder to i) determine the frequency of individual words in the text prompt (e.g., each word becomes a feature vector), ii) determine a weight for each word within the text prompt to generate a text vector that captures the importance of words within a text prompt, iii) generate low-dimensional text vectors in a continuous vector space that represents words within the text prompt, and/or iv) generate contextualized text vectors by determining semantic relationships between words within the text prompt.

Furthermore, although not shown in FIGS. 9-11, in one or more embodiments, the autonomous software agent system trains the set of artificial intelligence models 1120 (e.g., artificial intelligence components such as the code generation engine, the natural language processing, and the machine learning models). For example, the autonomous software agent system 100 leverages a set of large language models and fine-tunes each large language model for different tasks. In particular, the autonomous software agent system 100 has a large language model for terminal requests, a large language model for generating computer code, a large language model for generating a plan, and a large language model for performing website browsing actions and determining the relevance of certain portions of a website domain page.

Moreover, the autonomous software agent system 100 trains the set of artificial intelligence models 1120 by sending an input task to one or more of the large language models, generates a prediction for the input task, and compares the prediction with a ground truth reference. Based on the comparison, the autonomous software agent system 100 fine-tunes or modifies parameters of one or more large language models (e.g., that are part of the set of artificial intelligence models 1120). Thus, at inference time, the autonomous software agent system 100 performs advanced reasoning tasks fine-tuned for specific use cases.

In addition, as alluded to above, the autonomous software agent system 100 trains machine learning models to translate descriptions into code. In some embodiments, the autonomous software agent system 100 trains multiple machine learning models for discrete tasks. In particular, the autonomous software agent system 100 trains a machine learning model to generate specific types of functional code. For example, the autonomous software agent system 100 utilizes a machine learning model to generate computer code from a description and compares the description to a ground truth reference and fine-tunes/modifies parameters of the machine learning model.

Moreover, the autonomous software agent system 100 further continuously learns from feedback and developer interactions. In particular, the autonomous software agent system 100 deploys autonomous software agents that perform a variety of tasks, and in response to prompts and/or feedback (e.g., user intervention), the autonomous software agent system 100 learns from the interactions to improve its capabilities. In other words, the autonomous software agent system 100 fine-tunes the artificial intelligence components in response to updates/feedback received from users.

FIGS. 10-11 describe various architectural details of the autonomous software agent system 100. In particular, the architectural components of the autonomous software agent system 100 enable an autonomous software agent to perform a variety of tasks. To illustrate, the autonomous software agent system 100 performs repetitive coding tasks such as generating boilerplate code, data validation routines, and unit tests.

Moreover, the autonomous software agent system 100 performs code reviews (e.g., one or more software developers examine code written by others to identify potential issues and provide feedback) and debugging such as analyzing code to identify potential bugs and suggesting fixes/improvements. Furthermore, the autonomous software agent system 100 performs deployment automation to automate a deployment process of software (e.g., streamlining the transition from development to production).

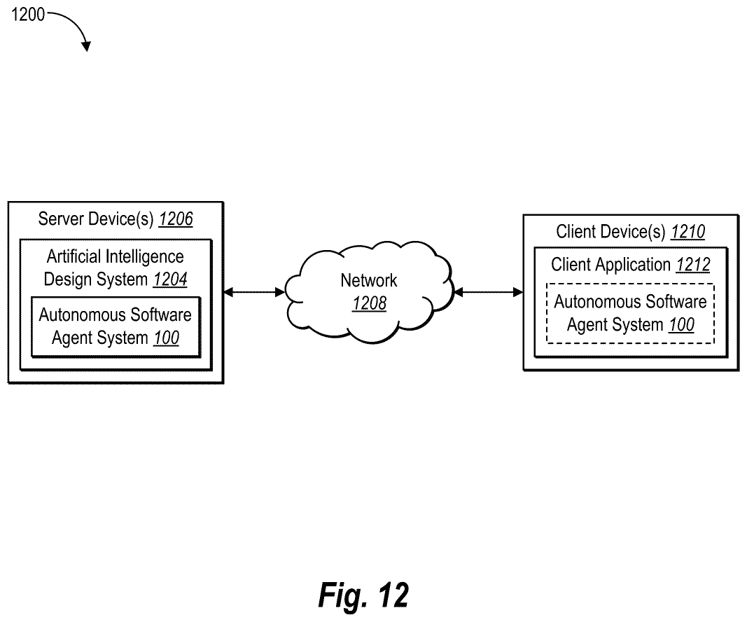

Additional details regarding the autonomous software agent system 100 will now be provided with reference to the figures. For example, FIG. 12 illustrates a schematic diagram of an exemplary system environment 1200 in which an autonomous software agent system 100 operates. As illustrated in FIG. 12, the system environment 1200 includes server device(s) 1206, an artificial intelligence design system 1204, a network 1208, and client device(s) 1210. Additionally, FIG. 12 illustrates that the artificial intelligence design system 1204 includes the autonomous software agent system 100.

Although the system environment 1200 of FIG. 12 is depicted as having a particular number of components, the system environment 1200 is capable of having a different number of additional or alternative components (e.g., a different number of servers, client devices, or other components in communication with the autonomous software agent system 100 via the network 1208). Similarly, although FIG. 12 illustrates a particular arrangement of the server device(s) 1206, the network 1208, and the client device(s) 1210, various additional arrangements are possible.

The server device(s) 1206, the network 1208, and the client device(s) 1210 are communicatively coupled with each other either directly or indirectly (e.g., through the network 1208 discussed in greater detail below). Moreover, the server device(s) 1206 and the client device(s) 1210 include one or more of a variety of computing devices (including one or more computing devices as discussed in greater detail below).

As mentioned above, the system environment 1200 includes the server device(s) 1206. In one or more embodiments, the server device(s) 1206 process input for a request (e.g., a request to configure an autonomous software agent or to deploy an autonomous software agent). In one or more embodiments, the server device(s) 1206 comprise a data server. In some implementations, the server device(s) 1206 comprise a communication server or a web-hosting server. Furthermore, the server device(s) 1206 can be associated with the autonomous software agent system 100 or with an organization/company that deploys the autonomous software agent system 100.

In some embodiments, the client device(s) 1210 includes computing devices associated with the one or more user accounts that submit requests for the autonomous software agent system 100. In some embodiments, the autonomous software agent system 100 trains one or more artificial intelligence models such as a code understanding model, one or more large language models, and a code generation model.

In one or more embodiments, the client device(s) 1210 includes smartphones, tablets, desktop computers, laptop computers, head-mounted-display devices, or other electronic devices. The client device(s) 1210 includes one or more software applications (e.g., the client application 1212) for generating content in accordance with the artificial intelligence design system 1204. In one or more embodiments, the client application 1212 includes a software application hosted on the server device(s) 1206 accessible by the client device(s) 1210 through another application, such as a web browser.

To provide an example implementation, in some embodiments, the autonomous software agent system 100 on the server device(s) 1206 supports the autonomous software agent system 100 on the client device(s) 1210. For instance, in some cases, the artificial intelligence design system 1204 on the server device(s) 1206 gathers data for the autonomous software agent system 100. In response, the autonomous software agent system 100, via the server device(s) 1206, provides the information to the client device(s) 1210. In other words, the client device(s) 1210 obtains (e.g., downloads) the autonomous software agent system 100 from the server device(s) 1206 that is already trained/optimized. Once downloaded, the autonomous software agent system 100 on the client device(s) 1210 is able to perform tasks (e.g., generative software tasks) independent from the server device(s) 1206. In one or more alternative implementations, the autonomous software agent system 100 generates or learns parameters for one or more artificial intelligence models (e.g., used to implement an autonomous software agent) in whole or in part on the client device(s) 1210.

In alternative implementations, the artificial intelligence design system 1204 includes a web hosting application that allows the client device(s) 1210 to interact with content and services hosted on the server device(s) 1206. To illustrate, in one or more implementations, the client device(s) 1210 accesses a software application supported by the server device(s) 1206. In response, the artificial intelligence design system 1204 on the server device(s) 1206 provides tools for monitoring/modifying/generating computer code using the autonomous software agent. In other words, the client device(s) 1210 does not have to download the autonomous software agent system 100 while still being able to access/utilize the trained/optimized tools provided by the artificial intelligence design system 1204 via a web hosting application.

In some embodiments, the autonomous software agent system 100 is implemented in whole, or in part, by the individual elements of the system environment 1200. For instance, although FIG. 12 illustrates the autonomous software agent system 100 implemented or hosted on the server device(s) 1206, different components of the autonomous software agent system 100 are able to be implemented by a variety of devices within the system environment 1200. For example, one or more (or all) components of the autonomous software agent system 100 are implemented by a different computing device or a separate server from the server device(s) 1206. Indeed, as shown in FIG. 12, the client device(s) 1210 includes the autonomous software agent system 100.

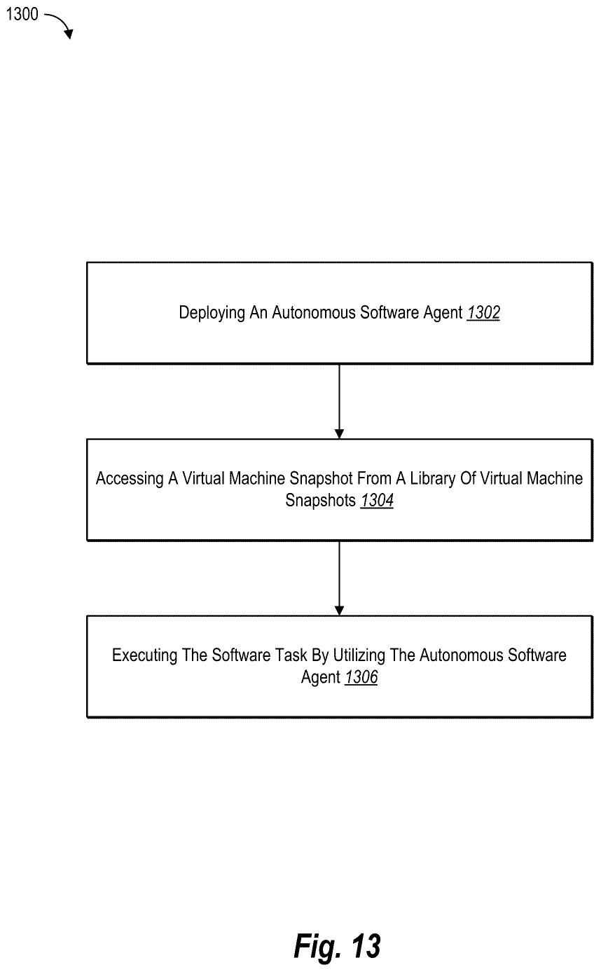

FIG. 13 illustrates a flowchart of a series of acts 1300 for utilizing an autonomous software agent to execute a software task within a custom software development environment in accordance with one or more embodiments. FIG. 13 illustrates acts according to one embodiment, alternative embodiments may omit, add to, reorder, and/or modify any of the acts shown in FIG. 13. In some implementations, the acts of FIG. 13 are performed as part of a method. For example, in some embodiments, the acts of FIG. 13 are performed as part of a computer-implemented method. Alternatively, a non-transitory computer-readable medium stores instructions thereon that, when executed by at least one processor, cause a computing device to perform the acts of FIG. 13. In some embodiments, a system performs the acts of FIG. 13. For example, in one or more embodiments, a system includes at least one memory device. The system further includes at least one server device configured to cause the system to perform the acts of FIG. 13.

The series of acts 1300 includes an act 1302 of deploying an autonomous software agent. Further, the series of acts 1300 includes an act 1304 of accessing a virtual machine snapshot from a library of virtual machine snapshots. Moreover, the series of acts 1300 includes an act 1306 of executing the software task by utilizing the autonomous software agent.

In particular, the act 1302 includes in response to a prompt to execute a software task, deploying an autonomous software agent. Further, the act 1304 includes accessing, utilizing the autonomous software agent, a virtual machine snapshot from a library of virtual machine snapshots, wherein the virtual machine snapshot is a custom software development environment comprising at least one of access to a code repository, access to one or more functional tools, or access to one or more code dependency libraries. Moreover, the act 1306 includes executing the software task by utilizing the autonomous software agent to perform one or more actions within the custom software development environment. The series of acts 1300 further includes the below clauses.

Clause 1. A computer-implemented method comprising: in response to a prompt to execute a software task, deploying an autonomous software agent; accessing, utilizing the autonomous software agent, a virtual machine snapshot from a library of virtual machine snapshots, wherein the virtual machine snapshot is a custom software development environment comprising at least one of access to a code repository, access to one or more functional tools, or access to one or more code dependency libraries; and executing the software task by utilizing the autonomous software agent to perform one or more actions within the custom software development environment.

Clause 2. The computer-implemented method of clause 1, further comprising: receiving a selection of the virtual machine snapshot from the library of virtual machine snapshots; and generating the custom software development environment according to access to the code repository, an access credential, a software test, the one or more functional tools, or the one or more code dependency libraries.

Clause 3. The computer-implemented method of any of clauses 1-2, further comprising generating the library of virtual machine snapshots by: receiving one or more virtual machine snapshots from one or more selections of a virtual machine snapshot configuration element; and storing a version history comprising a plurality of custom software development environments as virtual machine snapshots within the library of virtual machine snapshots.

Clause 4. The computer-implemented method of any of clauses 1-3, wherein executing the software task within the custom software development environment further comprises utilizing the autonomous software agent to prompt a graphical user interface to provide access to an additional code repository, an access credential, a software test, an additional functional tool, or an additional code dependency library.

Clause 5. The computer-implemented method of any of clauses 1-4, further comprising: receiving, via the graphical user interface, at least one of access to the additional code repository, the access credential, the software test, the additional functional tool, or the additional code dependency library; and updating the custom software development environment based on receiving access to at least one of the additional code repository, the access credential, the software test, the additional functional tool, or the additional code dependency library.

Clause 6. The computer-implemented method of any of clauses 1-5, further comprising determining, from executing the software task, an updated custom software development environment of the autonomous software agent, wherein the updated custom software development environment comprises at least one of an environment configuration, disk content, memory, or environment settings that are different relative to the custom software development environment.

Clause 7. The computer-implemented method of any of clauses 1-6, further comprising storing the updated custom software development environment as an additional virtual machine snapshot of the autonomous software agent within the library of virtual machine snapshots.

Clause 8. The computer-implemented method of any of clauses 1-7, further comprising in response to an additional prompt to execute an additional software task, deploying an additional autonomous software agent that operates within the updated custom software development environment based on a selection of the additional virtual machine snapshot.

Clause 9. A non-transitory computer-readable medium storing executable instructions which, when executed by at least one processing device, cause the at least one processing device to perform operations comprising: in response to a prompt to execute a software task, deploying an autonomous software agent; accessing, utilizing the autonomous software agent, a virtual machine snapshot from a library of virtual machine snapshots, wherein the virtual machine snapshot is a custom software development environment comprising at least one of access to a code repository, access to one or more functional tools, or access to one or more code dependency libraries; and executing the software task by utilizing the autonomous software agent to perform one or more actions within the custom software development environment.

Clause 10. The non-transitory computer-readable medium of clause 9, further comprising configuring a virtual machine snapshot by: receiving, via a virtual machine snapshot configuration element, access to a code repository; and in response to receiving access, generating artificial intelligence setup suggestions for the code repository.

Clause 11. The non-transitory computer-readable medium of any of clauses 9-10, wherein generating the artificial intelligence setup suggestions comprises: generating a code repository pull suggestion comprising a command to pull recent changes from the code repository; and generating an access credential suggestion for requesting secrets or environment variables to operate within the code repository.

Clause 12. The non-transitory computer-readable medium of any of clauses 9-11, further comprising: generating an install dependency suggestion for requesting code dependencies to operate within the code repository; and generating a software test suggestion for testing computer code within the code repository.

Clause 13. The non-transitory computer-readable medium of any of clauses 9-12, further comprising: providing, for display on a graphical user interface, confirmation options for the artificial intelligence setup suggestions; and deploying the autonomous software agent to perform one or more actions within the custom software development environment according to one or more confirmations of the artificial intelligence setup suggestions.

Clause 14. The non-transitory computer-readable medium of any of clauses 9-13, wherein deploying the autonomous software agent further comprises: initializing a development session comprising the custom software development environment hosted on a virtual private cloud and an autonomous agent model backend comprising a set of large language models; and transmitting, from executing the software task, encrypted communications between the virtual private cloud that hosts the custom software development environment and the autonomous agent model backend.

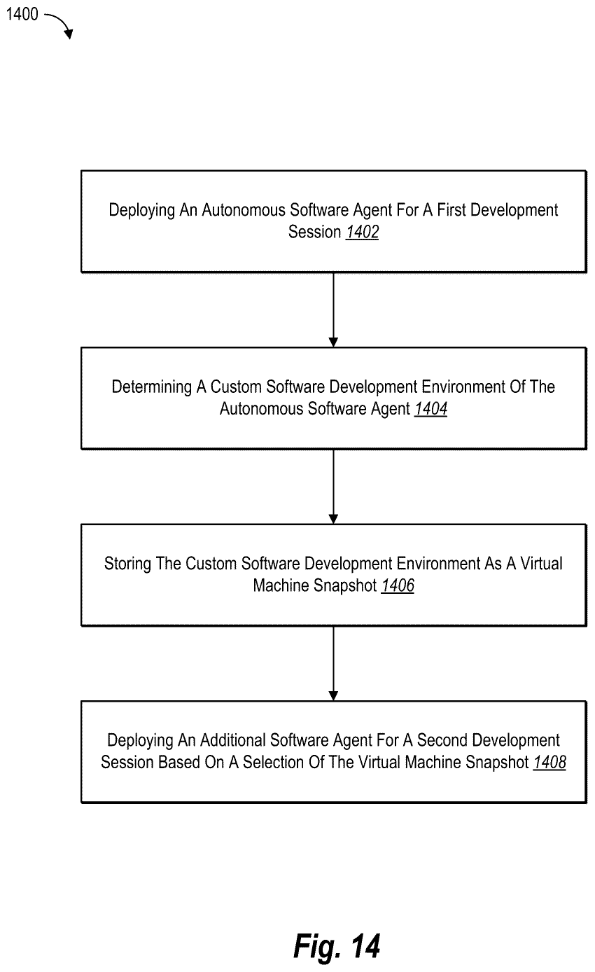

FIG. 14 illustrates a flowchart of a series of acts 1400 for determining a custom software development environment and storing the custom software development environment in accordance with one or more embodiments. FIG. 14 illustrates acts according to one embodiment, alternative embodiments may omit, add to, reorder, and/or modify any of the acts shown in FIG. 14. In some implementations, the acts of FIG. 14 are performed as part of a method. For example, in some embodiments, the acts of FIG. 14 are performed as part of a computer-implemented method. Alternatively, a non-transitory computer-readable medium stores instructions thereon that, when executed by at least one processor, cause a computing device to perform the acts of FIG. 14. In some embodiments, a system performs the acts of FIG. 14. For example, in one or more embodiments, a system includes at least one memory device. The system further includes at least one server device configured to cause the system to perform the acts of FIG. 14.

The series of acts 1400 includes an act 1402 of deploying an autonomous software agent for a first development session. Further, the series of acts 1400 includes an act 1404 of determining a custom software development environment of the autonomous software agent. Moreover, the series of acts 1400 includes an act 1406 of storing the custom software development environment as a virtual machine snapshot. Additionally, the series of acts 1400 includes an act 1408 of deploying an additional software agent for a second development session based on a selection of the virtual machine snapshot.

In particular, the act 1402 includes in response to a prompt to execute a software task, deploying an autonomous software agent for a first development session. Further, the act 1404 includes determining, from executing the software task, a custom software development environment of the autonomous software agent, wherein the custom software development environment comprises at least one of an environment configuration, disk content, memory, or environment settings. Moreover, the act 1406 includes storing the custom software development environment as a virtual machine snapshot of the autonomous software agent for the first development session. Additionally, the act 1408 includes in response to an additional prompt to execute an additional software task, deploying an additional software agent for a second development session that operates within the custom software development environment based on a selection of the virtual machine snapshot. The series of acts 1400 further includes the below clauses.

Clause 15. A system comprising: one or more memory devices; and one or more processors coupled to the one or more memory devices, configured to cause the system to: in response to a prompt to execute a software task, deploy an autonomous software agent for a first development session; determine, from executing the software task, a custom software development environment of the autonomous software agent, wherein the custom software development environment comprises at least one of an environment configuration, disk content, memory, or environment settings; store the custom software development environment as a virtual machine snapshot of the autonomous software agent for the first development session; and in response to an additional prompt to execute an additional software task, deploy an additional software agent for a second development session that operates within the custom software development environment based on a selection of the virtual machine snapshot.

Clause 16. The system of clause 15, wherein the one or more processors are configured to cause the system to: execute, utilizing the autonomous software agent, a first sub-task of the software task; and determine from executing the first sub-task of the software task, a first sub-task custom software development environment of the autonomous software agent.

Clause 17. The system of any of clauses 15-16, wherein the one or more processors are configured to cause the system to: execute, utilizing the autonomous software agent, a second sub-task of the software task; determine from executing the second sub-task of the software task, a second sub-task custom software development environment of the autonomous software agent; and store the first sub-task custom software development environment and the second sub-task custom software development environment within a version history of virtual machine snapshots for the first development session.

Clause 18. The system of any of clauses 15-17, wherein the one or more processors are configured to cause the system to in response to the autonomous software agent completing execution of the software task for the first development session, store the custom software development environment within a version history of virtual machine snapshots for the first development session.

Clause 19. The system of any of clauses 15-18, wherein the one or more processors are configured to cause the system to: receive another prompt to deploy another autonomous software agent for a third development session and a selection of the custom software development environment from a library of virtual machine snapshots; and receive a selection of a configuration element to modify the custom software development environment.

Clause 20. The system of any of clauses 15-19, wherein the one or more processors are configured to cause the system to: modify access to code repositories, access credentials, software tests, functional tools, or code dependency libraries; and deploy another autonomous software agent for the third development session to execute another software task within a modified custom software development environment.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

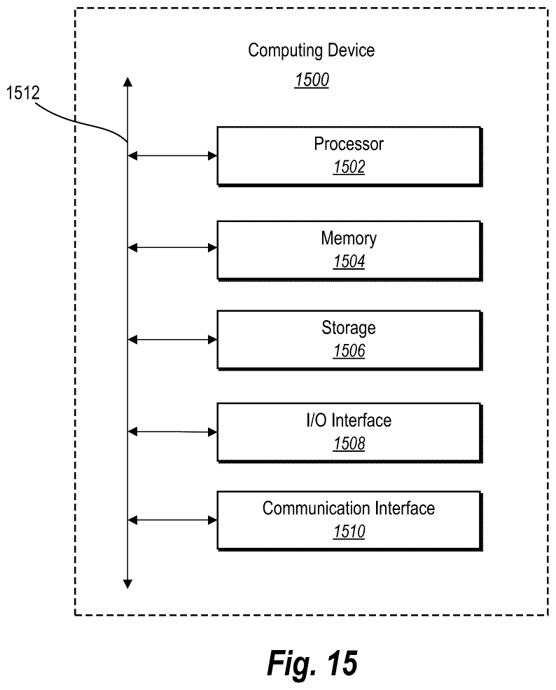

FIG. 15 illustrates a block diagram of an example computing device 1500 that may be configured to perform one or more of the processes described above. One will appreciate that one or more computing devices, such as the computing device 1500 may represent the computing devices described above (e.g., the server device(s) 1206 and/or the client device(s) 1210). In one or more embodiments, the computing device 1500 may be a mobile device (e.g., a mobile telephone, a smartphone, a PDA, a tablet, a laptop, a camera, a tracker, a watch, a wearable device). In some embodiments, the computing device 1500 may be a non-mobile device (e.g., a desktop computer or another type of client device). Further, the computing device 1500 may be a server device that includes cloud-based processing and storage capabilities.

As shown in FIG. 15, the computing device 1500 can include one or more processor(s) 1502, memory 1504, a storage device 1506, input/output interfaces 1508 (or “I/O interfaces 1508”), and a communication interface 1510, which may be communicatively coupled by way of a communication infrastructure (e.g., bus 1512). While the computing device 1500 is shown in FIG. 15, the components illustrated in FIG. 15 are not intended to be limiting. Additional or alternative components may be used in other embodiments. Furthermore, in certain embodiments, the computing device 1500 includes fewer components than those shown in FIG. 15. Components of the computing device 1500 shown in FIG. 15 will now be described in additional detail.

In particular embodiments, the processor(s) 1502 include hardware for executing instructions, such as those making up a computer program. As an example, and not by way of limitation, to execute instructions, the processor(s) 1502 may retrieve (or fetch) the instructions from an internal register, an internal cache, memory 1504, or a storage device 1506 and decode and execute them.

The computing device 1500 includes memory 1504, which is coupled to the processor(s) 1502. The memory 1504 may be used for storing data, metadata, and programs for execution by the processor(s). The memory 1504 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1504 may be internal or distributed memory.

The computing device 1500 includes a storage device 1506 including storage for storing data or instructions. As an example, and not by way of limitation, the storage device 1506 can include a non-transitory storage medium described above. The storage device 1506 may include a hard disk drive (HDD), flash memory, a Universal Serial Bus (USB) drive or a combination these or other storage devices.

As shown, the computing device 1500 includes one or more I/O interfaces 1508, which are provided to allow a user to provide input to (such as user strokes), receive output from, and otherwise transfer data to and from the computing device 1500. These I/O interfaces 1508 may include a mouse, keypad or a keyboard, a touch screen, camera, optical scanner, network interface, modem, other known I/O devices or a combination of such I/O interfaces 1508. The touch screen may be activated with a stylus or a finger.

The I/O interfaces 1508 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1508 are configured to provide graphical data to a display for presentation to a user. The graphical data may be representative of one or more graphical user interfaces and/or any other graphical content as may serve a particular implementation.

The computing device 1500 can further include a communication interface 1510. The communication interface 1510 can include hardware, software, or both. The communication interface 1510 provides one or more interfaces for communication (such as, for example, packet-based communication) between the computing device and one or more other computing devices or one or more networks. As an example, and not by way of limitation, communication interface 1510 may include a network interface controller (NIC) or network adapter for communicating with an Ethernet or other wire-based network or a wireless NIC (WNIC) or wireless adapter for communicating with a wireless network, such as a WI-FI. The computing device 1500 can further include a bus 1512. The bus 1512 can include hardware, software, or both that connects components of computing device 1500 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
in response to a prompt to execute a software task, deploying an autonomous software agent;
accessing, utilizing the autonomous software agent, a virtual machine snapshot from a library of virtual machine snapshots, wherein the virtual machine snapshot is a custom software development environment comprising at least one of access to a code repository, access to one or more functional tools, or access to one or more code dependency libraries; and
executing the software task by utilizing the autonomous software agent to perform one or more actions within the custom software development environment.

2. The computer-implemented method of claim 1, further comprising:
receiving a selection of the virtual machine snapshot from the library of virtual machine snapshots; and
generating the custom software development environment according to access to the code repository, an access credential, a software test, the one or more functional tools, or the one or more code dependency libraries.

3. The computer-implemented method of claim 1, further comprising generating the library of virtual machine snapshots by:
receiving one or more virtual machine snapshots from one or more selections of a virtual machine snapshot configuration element; and
storing a version history comprising a plurality of custom software development environments as virtual machine snapshots within the library of virtual machine snapshots.

4. The computer-implemented method of claim 1, wherein executing the software task within the custom software development environment further comprises utilizing the autonomous software agent to prompt a graphical user interface to provide access to an additional code repository, an access credential, a software test, an additional functional tool, or an additional code dependency library.

5. The computer-implemented method of claim 4, further comprising:
receiving, via the graphical user interface, at least one of access to the additional code repository, the access credential, the software test, the additional functional tool, or the additional code dependency library; and
updating the custom software development environment based on receiving access to at least one of the additional code repository, the access credential, the software test, the additional functional tool, or the additional code dependency library.

6. The computer-implemented method of claim 1, further comprising determining, from executing the software task, an updated custom software development environment of the autonomous software agent, wherein the updated custom software development environment comprises at least one of an environment configuration, disk content, memory, or environment settings that are different relative to the custom software development environment.

7. The computer-implemented method of claim 6, further comprising storing the updated custom software development environment as an additional virtual machine snapshot of the autonomous software agent within the library of virtual machine snapshots.

8. The computer-implemented method of claim 7, further comprising in response to an additional prompt to execute an additional software task, deploying an additional autonomous software agent that operates within the updated custom software development environment based on a selection of the additional virtual machine snapshot.

9. A system comprising:
one or more memory devices; and
one or more processors coupled to the one or more memory devices, configured to cause the system to perform operations comprising:
in response to a prompt to execute a software task, deploying an autonomous software agent for a first development session;
determine, from executing the software task, a custom software development environment of the autonomous software agent, wherein the custom software development environment comprises at least one of an environment configuration, disk content, memory, or environment settings;
store the custom software development environment as a virtual machine snapshot of the autonomous software agent for the first development session; and
in response to an additional prompt to execute an additional software task, deploy an additional software agent for a second development session that operates within the custom software development environment based on a selection of the virtual machine snapshot.

10. The system of claim 9, wherein the one or more processors are configured to cause the system to:
execute, utilizing the autonomous software agent, a first sub-task of the software task; and
determine from executing the first sub-task of the software task, a first sub-task custom software development environment of the autonomous software agent.

11. The system of claim 10, wherein the one or more processors are configured to cause the system to:
execute, utilizing the autonomous software agent, a second sub-task of the software task;
determine from executing the second sub-task of the software task, a second sub-task custom software development environment of the autonomous software agent; and
store the first sub-task custom software development environment and the second sub-task custom software development environment within a version history of virtual machine snapshots for the first development session.

12. The system of claim 9, wherein the one or more processors are configured to cause the system to in response to the autonomous software agent completing execution of the software task for the first development session, store the custom software development environment within a version history of virtual machine snapshots for the first development session.

13. The system of claim 12, wherein the one or more processors are configured to cause the system to:
receive another prompt to deploy another autonomous software agent for a third development session and a selection of the custom software development environment from a library of virtual machine snapshots; and
receive a selection of a configuration element to modify the custom software development environment.

14. The system of claim 13, wherein the one or more processors are configured to cause the system to:
modify access to code repositories, access credentials, software tests, functional tools, or code dependency libraries; and
deploy the another autonomous software agent for the third development session to execute another software task within a modified custom software development environment.

15. A non-transitory computer-readable medium storing executable instructions which, when executed by at least one processing device, cause the at least one processing device to perform operations comprising:
in response to a prompt to execute a software task, deploying an autonomous software agent;
accessing, utilizing the autonomous software agent, a virtual machine snapshot from a library of virtual machine snapshots, wherein the virtual machine snapshot is a custom software development environment comprising at least one of access to a code repository, access to one or more functional tools, or access to one or more code dependency libraries; and
executing the software task by utilizing the autonomous software agent to perform one or more actions within the custom software development environment.

16. The non-transitory computer-readable medium of claim 15, further comprising configuring a virtual machine snapshot by:
receiving, via a virtual machine snapshot configuration element, access to a code repository; and
in response to receiving access, generating artificial intelligence setup suggestions for the code repository.

17. The non-transitory computer-readable medium of claim 16, wherein generating the artificial intelligence setup suggestions comprises:
generating a code repository pull suggestions comprising a command to pull recent changes from the code repository; and
generating an access credential suggestion for requesting secrets or environment variables to operate within the code repository.

18. The non-transitory computer-readable medium of claim 16, further comprising:
generating an install dependency suggestion for requesting code dependencies to operate within the code repository; and
generating a software test suggestion for testing computer code within the code repository.

19. The non-transitory computer-readable medium of claim 16, further comprising:
providing, for display on a graphical user interface, confirmation options for the artificial intelligence setup suggestions; and
deploying the autonomous software agent to perform one or more actions within the custom software development environment according to one or more confirmations of the artificial intelligence setup suggestions.

20. The non-transitory computer-readable medium of claim 15, wherein deploying the autonomous software agent further comprises:
initializing a development session comprising the custom software development environment hosted on a virtual private cloud and an autonomous agent model backend comprising a set of large language models; and
transmitting, from executing the software task, encrypted communications between the virtual private cloud that hosts the custom software development environment and the autonomous agent model backend.
